(19) United States
(12) Patent Application Publication
(10) Pub. No.: US 2014/0033509 A1
(43) Pub. Date: Feb. 6, 2014

(54) Advantageous Clamp

(71) Applicant: Paul E. Sidwell, Duluth, GA (US)

(72) Inventor: Paul E. Sidwell, Duluth, GA (US)

(73) Assignee: Maximum Visibility Solutions, LLC, Duluth, GA (US)

(21) Appl. No.: 13/564,320

(22) Filed: Aug. 1, 2012

(51) Int. Cl. F16B 2/10; F16B 2/20; B23P 11/00

(52) U.S. Cl. 29/525.08; 24/564; 24/499

(57) ABSTRACT

Advantageous clamps, methods of forming the same, and methods of using the same are provided. A clamp can include two jaws and a spring member configured to push the two jaws together. One jaw can have an inner surface including a plurality of flat portions connected by smooth, curved portions. The clamp can advantageously ensure a large surface area of contact between the clamp and a substrate, thereby inhibiting tilting and slipping of the clamp.

### BACKGROUND OF THE INVENTION

Clamps can be used for a variety of purposes, including to attach objects to a substrate or to hold two substrates together. For example, a clamp can be used to affix a sign, balloon assembly, or other attention-garnering object to a shelf, other sign, or other retail article.

Existing clamps are typically made with two completely flat jaws. Such a configuration leads to poor surface contact between the clamp and the substrate in most situations. Only when the thickness of the substrate is equal to the distance between the two jaws at their connection point is good surface contact achieved.

The poor surface contact of existing clamps leads to tilting, slipping, and loss of grip, even when no object is attached, but especially when a heavy object is attached to the clamp. This is especially true if a long object is attached, with another object having weight attached at the end of the long object and above or to a side of the clamp. This leads to tilting and slipping of the clamp and, therefore, movement of the displayed object to a lower location (e.g., out of the ideal viewing window for consumers, in a retail setting).

### BRIEF SUMMARY OF THE INVENTION

Embodiments of the subject invention relate to advantageous clamps, methods of forming the same, and methods of using the same. A clamp of the subject invention can advantageously grip a multitude of surfaces having a wide range of thicknesses, without tilting, slipping, or losing grip.

In an embodiment, a clamp can include: a first jaw; a second jaw connected to the first jaw; and a spring member configured to push the first jaw towards the second jaw. The first jaw can include an inner surface having a first flat portion, a second flat portion, and a third flat portion. The first flat portion can be connected to the second flat portion by a first curved portion, and the second flat portion can be connected to the third flat portion by a second curved portion.

In a further embodiment, a method of affixing an object to a substrate can include: affixing a clamp to the substrate; and attaching the object to the clamp, wherein the clamp can include: a first jaw; a second jaw connected to the first jaw; and a spring member configured to push the first jaw towards the second jaw. The first jaw can include an inner surface having a first flat portion, a second flat portion, and a third flat portion. The first flat portion can be connected to the second flat portion by a first curved portion, and the second flat portion can be connected to the third flat portion by a second curved portion.

In yet a further embodiment, a method of forming a clamp can include: forming a first jaw; forming a second jaw; connecting the first jaw to the second jaw; and connecting a spring member to the first jaw and the second jaw. The spring member can be configured to push the first jaw towards the second jaw, and the first jaw can include an inner surface having a first flat portion, a second flat portion, and a third flat portion. The first flat portion can be connected to the second flat portion by a first curved portion, and the second flat portion can be connected to the third flat portion by a second curved portion.

### BRIEF DESCRIPTION OF THE DRAWINGS

FIG. 1 shows a perspective view of a clamp according to an embodiment of the subject invention.

FIG. 2 shows a perspective view of a clamp according to an embodiment of the subject invention.

FIG. 3 shows a perspective view of a clamp according to an embodiment of the subject invention.

FIG. 4 shows a perspective view of a rod that can be used with a clamp according to an embodiment of the subject invention.

FIG. 5 shows a perspective view of a clamp according to an embodiment of the subject invention.

FIG. 6 shows a perspective view of a clamp according to an embodiment of the subject invention.

FIG. 7 shows a perspective view of a clamp according to an embodiment of the subject invention.

FIG. 8 shows a perspective view of a clamp according to an embodiment of the subject invention.

FIG. 9 shows a perspective view of a clamp according to an embodiment of the subject invention.

FIG. 10 shows a perspective view of a portion of a clamp according to an embodiment of the subject invention.

FIG. 11 shows a perspective view of a portion of a rod that can be used with a clamp according to an embodiment of the subject invention.

FIG. 12 shows a perspective view of a portion of a clamp according to an embodiment of the subject invention.

FIG. 13 shows a perspective view of a clamp according to an embodiment of the subject invention.

FIG. 14 shows a perspective view of a clamp according to an embodiment of the subject invention.

FIG. 15 shows an image of two clamps according to embodiments of the subject invention.

FIG. 16 shows an image of a clamp according to an embodiment of the subject invention.

FIG. 17 shows an image of a clamp according to an embodiment of the subject invention.

FIG. 18 shows an image of a clamp according to an embodiment of the subject invention.

FIG. 19 shows an image of a clamp according to an embodiment of the subject invention.

FIG. 20 shows an image of a clamp according to an embodiment of the subject invention.

FIG. 21 shows an image of a clamp according to an embodiment of the subject invention.

FIG. 22 shows an image of a clamp according to an embodiment of the subject invention.

FIG. 23 shows an image of a clamp according to an embodiment of the subject invention.

FIG. 24 shows a top view of a second jaw according to an embodiment of the subject invention.

FIG. 25 shows a cross-sectional view taken along line A-A of the second jaw in FIG. 24.

FIG. 26 shows a perspective view of a second jaw according to an embodiment of the subject invention.

FIG. 27 shows a side view, a top view, and a perspective view of a rod insertion member that can be used with a clamp according to an embodiment of the subject invention.

FIG. 28 shows a top view of a first jaw according to an embodiment of the subject invention.

FIG. 29 shows a cross-sectional view taken along line A-A of the first jaw in FIG. 28.

FIG. 30 shows a perspective view of a first jaw according to an embodiment of the subject invention.

FIG. 31 shows a cross-sectional view of a first jaw according to an embodiment of the subject invention.

FIG. 32A shows a side view of a portion of a rod attachment member that can be used with a clamp according to an embodiment of the subject invention.

FIG. 32B shows a top view of a portion of a rod attachment member that can be used with a clamp according to an embodiment of the subject invention.

FIG. 32C shows a side view of a portion of a rod attachment member that can be used with a clamp according to an embodiment of the subject invention.

FIG. 33 shows a cross-sectional view of a portion of a rod attachment member that can be used with a clamp according to an embodiment of the subject invention.

FIG. 34 shows a cross-sectional view of a portion of a rod attachment member that can be used with a clamp according to an embodiment of the subject invention.

FIG. 35 shows side, top, and perspective views of a spring member according to an embodiment of the subject invention.

FIG. 36 shows a cross-sectional view of a spring member according to an embodiment of the subject invention.

### DETAILED DISCLOSURE OF THE INVENTION

When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

In addition, references to “first”, “second”, and the like (e.g., first and second portion), as used herein, and unless otherwise specifically stated, are intended to identify a particular feature of which there may be more than one. Such reference to “first” does not imply that there must be two or more. These references are not intended to confer any order in time, structural orientation, or sidedness (e.g., left or right) with respect to a particular feature, unless explicitly stated.

Embodiments of the subject invention relate to advantageous clamps, methods of forming the same, and methods of using the same. A clamp of the subject invention can advantageously grip a multitude of surfaces having a wide range of thicknesses, without tilting, slipping, or losing grip. Clamps of the subject invention can include one or more mounting attachments for attaching items to the clamp. For example, a clamp of the subject invention can grip a shelf, board, sign, wall, or other surface and can have a pole or rod attached to it. Such a pole or rod can then have, for example, a sign or a balloon assembly (e.g., an assembly for a non-helium balloon). Thus, a clamp of the subject invention can be used with, for example, a balloon assembly as described in U.S. Design Pat. No. D529,102 or U.S. Pat. No. 7,588,477, both of which are incorporated by reference herein in their entireties.

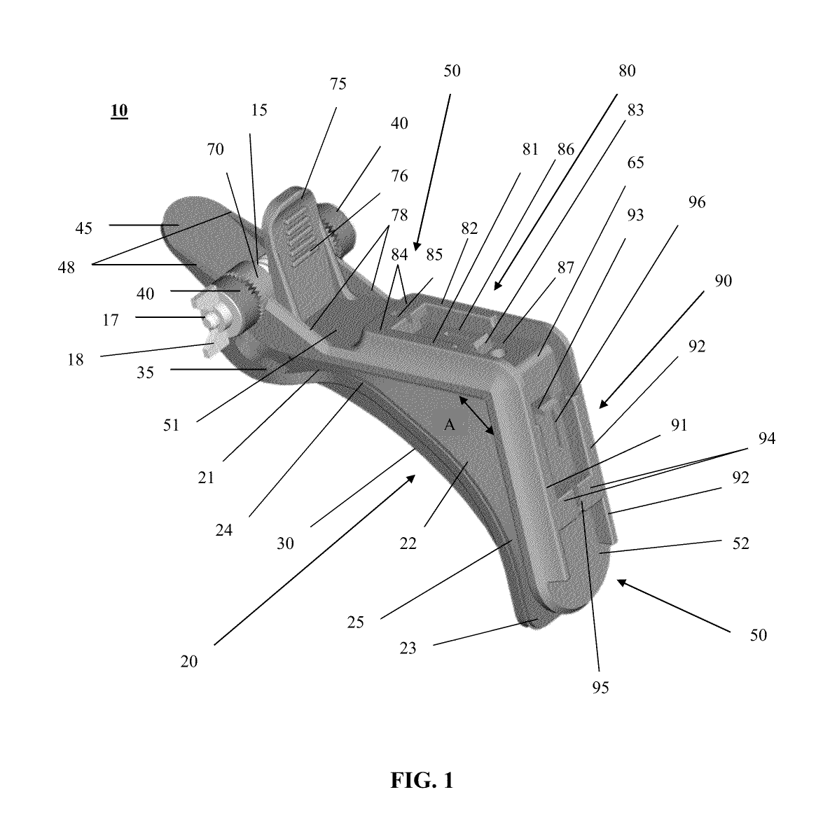

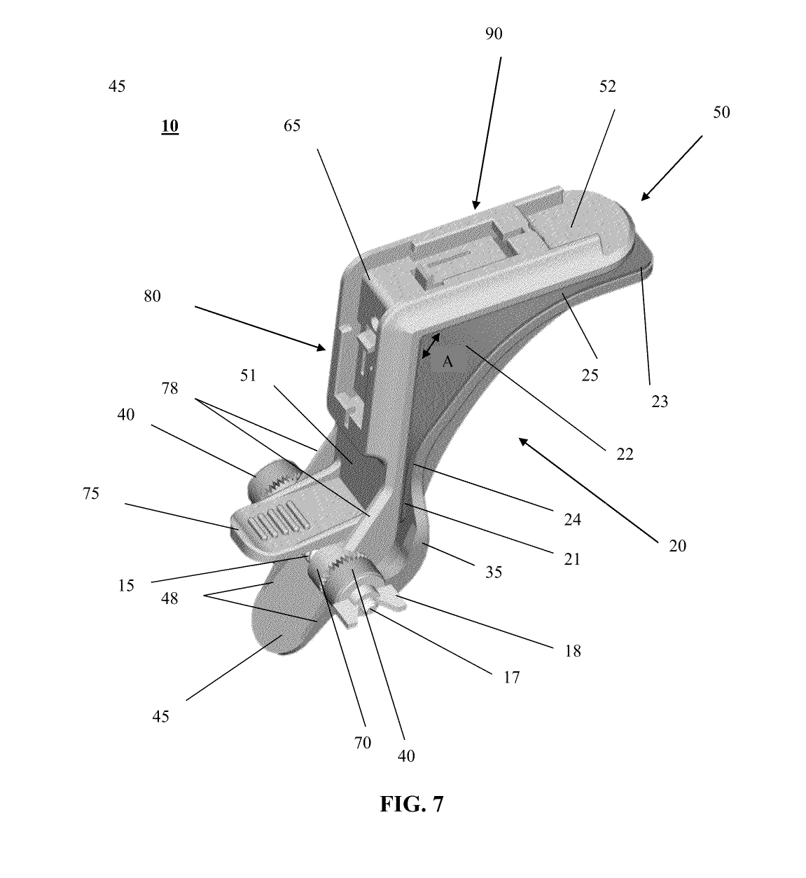

Referring to FIGS. 1 and 7, in many embodiments, a clamp 10 can include a first jaw 20 and a second jaw 50 forming the two main portions of the clamp. The first jaw 20 can include a plurality of flat or essentially flat portions (e.g., 21, 22, and 23) connected to each other by curved portions (e.g., 24 and 25). Though a clamp with three flat or essentially flat portions and two curved portions is shown, embodiments of the subject invention are not limited thereto. For example, a clamp can include 2, 4, 5, 6, 7, 8, 9, 10, etc. flat or essentially flat portions and 1, 3, 4, 5, 6, 7, 8, 9, etc. curved portions. The curve of each curved portion can be smooth and/or undulating. That is, the curves can be gradual. The flat or essentially portions can be on an inner surface of the first jaw 20, i.e., the surface that faces the second jaw 50 once the clamp is assembled. A clamp having a jaw portion with a plurality of flat portions (e.g., 21, 22, and 23) connected to each other by curved portions (e.g., 24 and 25) can advantageously increase the surface area contact between the jaw portion and the substrate to which it is affixed in use. Thus, the clamp 10 “finds the corner,” meaning that the inner surface of the jaw portion having a plurality of flat portions contacts the substrate in an advantageous manner, increasing the stability of the clamp, even when large loads are attached thereto, and inhibiting tilting and slipping.

In many embodiments, the second jaw 50 can have a first portion 51 and a second portion 52 formed at an angle A with respect to one another. That is, the plane in which the inner, relatively flat surface of the first portion 51 lies is at an angle A with respect to the plane in which the inner, relatively flat surface of the second portion 52 lies. The inner surface refers to the surface that faces the first jaw 20 when the clamp is assembled. The outer surface of the first portion 51 and the outer surface of the second portion 52 can be connected by an outer curved portion 65. The angle A between the first 51 and second 52 portions of the second jaw 50 can be, for example, any of the following values or within any range having any of the following values as endpoints, though embodiments are not limited thereto (all numerical values are in degrees): 60, 65, 70, 75, 80, 81, 82, 83, 84, 85, 86, 87, 88, 89, 89.5, 90, 90.5, 91, 92, 93, 94, 95, 96, 97, 98, 99, 100, 105, 110, 115, 120, about 80, about 81, about 82, about 83, about 84, about 85, about 86, about 87, about 88, about 89, about 89.5, about 90, about 90.5, about 91, about 92, about 93, about 94, about 95, about 96, about 97, about 98, about 99, or about 100. For example, the angle A between the first 51 and second 52 portions of the second jaw 50 can be 90 degrees or about 90 degrees.

In an embodiment, the width of the first jaw 20 can remain constant or essentially constant along its length. In an alternative embodiment, the width of the first jaw 20 can vary along its length. For example, the first jaw 20 can be wider at a distal end from the spring 15 than it is at a proximal end to the spring 15. Alternatively, the first jaw 20 can be narrower at a distal end from the spring 15 than it is at a proximal end to the spring 15. The width of the first jaw 20 can taper evenly from the wider end to the narrower end or its width can vary, going wider and narrower, one or more times from one end to the other.

In an embodiment, the width of the second jaw 50 can remain constant or essentially constant along its length. In an alternative embodiment, the width of the second jaw 50 can vary along its length. For example, the second jaw 50 can be wider at a distal end from the spring 15 (e.g., the end of the second portion 52) than it is at a proximal end to the spring 15 (e.g., near the first portion 51). Alternatively, the second jaw 50 can be narrower at a distal end from the spring 15 than it is at a proximal end to the spring 15. The width of the second jaw 50 can taper evenly from the wider end to the narrower end or its width can vary, going wider and narrower, one or more times from one end to the other.

In an embodiment, the thickness of the first jaw 20 can vary along its length. For example, the first jaw 20 can be thicker at a distal end from the spring 15 than it is at a proximal end to the spring 15. Alternatively, the first jaw 20 can be thinner at a distal end from the spring 15 than it is at a proximal end to the spring 15. The thickness of the first jaw 20 can decrease evenly from the thicker end to the thinner end or its thickness can vary, going thicker and thinner, one or more times from one end to the other. In an alternative embodiment, the thickness of the first jaw 20 can remain constant or essentially constant along its length.

In an embodiment, the thickness of the second jaw 50 can remain constant or essentially constant along its length. In an alternative embodiment, the thickness of the second jaw 50 can vary along its length. For example, the second jaw 50 can be thicker at a distal end from the spring 15 (e.g., the end of the second portion 52) than it is at a proximal end to the spring 15 (e.g., near the first portion 51). Alternatively, the second jaw 50 can be thinner at a distal end from the spring 15 than it is at a proximal end to the spring 15. The thickness of the second jaw 50 can decrease evenly from the thicker end to the thinner end or its thickness can vary, going thicker and thinner, one or more times from one end to the other.

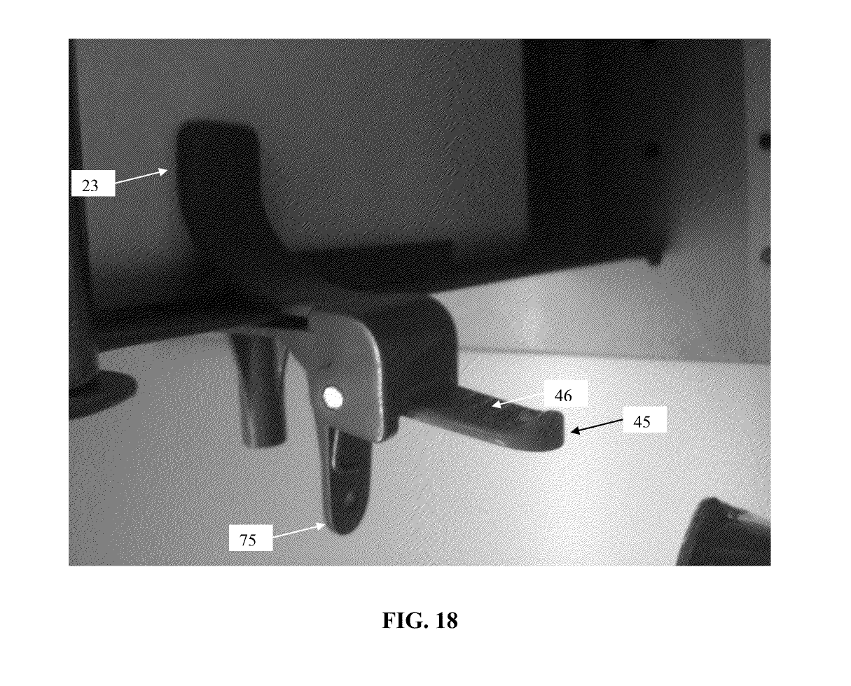

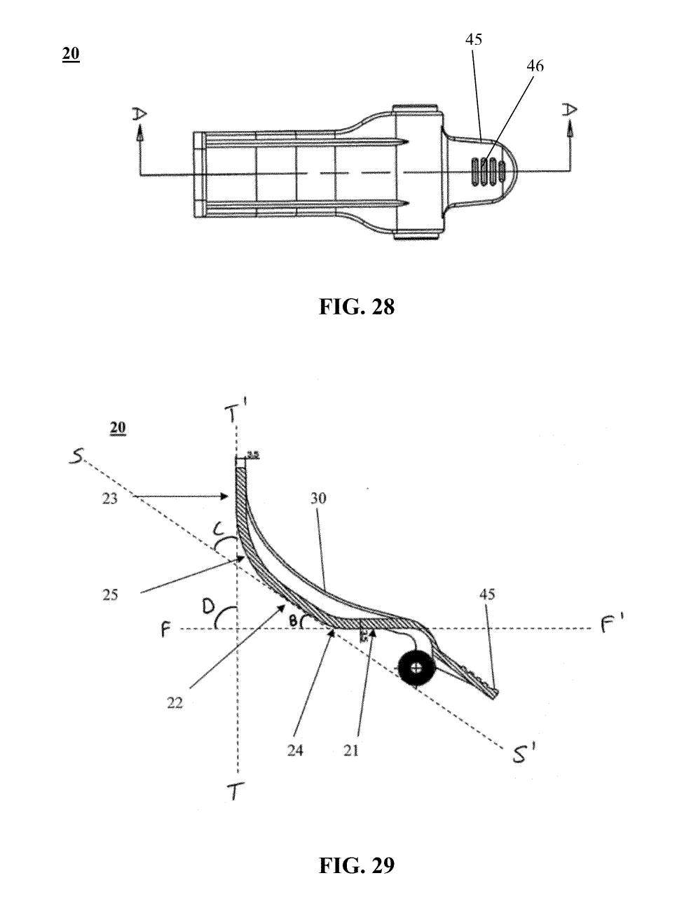

In many embodiments, the first jaw 20 can have a tab portion 45 which can be used to open the clamp by applying pressure toward a tab portion 75 of the second jaw 50, e.g., by using one or more fingers. The tab portion can have one or more ridge protrusions 46 (seen in, e.g., FIGS. 18 and 28), though embodiments are not limited thereto. Such ridge protrusions 46 can increase the friction between a user's finger(s) and the tab portion 45 of the first jaw 20. Also, the second jaw 50 can have a tab portion 75 which can be used to open the clamp by applying pressure toward the tab portion 45 of the first jaw 20, e.g., by using one or more fingers. The tab portion can have one or more ridge protrusions 76, though embodiments are not limited thereto. Such ridge protrusions 76 can increase the friction between a user's finger(s) and the tab portion 75 of the second jaw 50. The clamp 10 can also include a spring member 15 applying force against the tab portion 45 of the first jaw 20 and against the tab portion 75 of the second jaw 50, such that the spring member 15 pushes the second portion 52 of the second jaw 50 towards the distal end (away from the tab portion 45) of the first jaw 20. The spring member 15 also allows the clamp to be opened by applying adequate pressure on the tab portions 45, 75 towards each other, thereby moving the distal end (away from the tab portion 75) of the second jaw 50 away from the distal end of the first jaw 20.

In an embodiment, the first jaw 20 can have an inner surface having three flat or essentially portions 21, 22, 23, such that the first flat portion 21 is connected to the second flat portion 22 by a first curved portion 24 and the second flat portion 22 is connected to the third flat portion 23 by a second curved portion 25. In a particular embodiment, the first flat portion 21 can be proximal to the tab portion 45, and the third flat portion 23 can be distal to the tab portion 45.

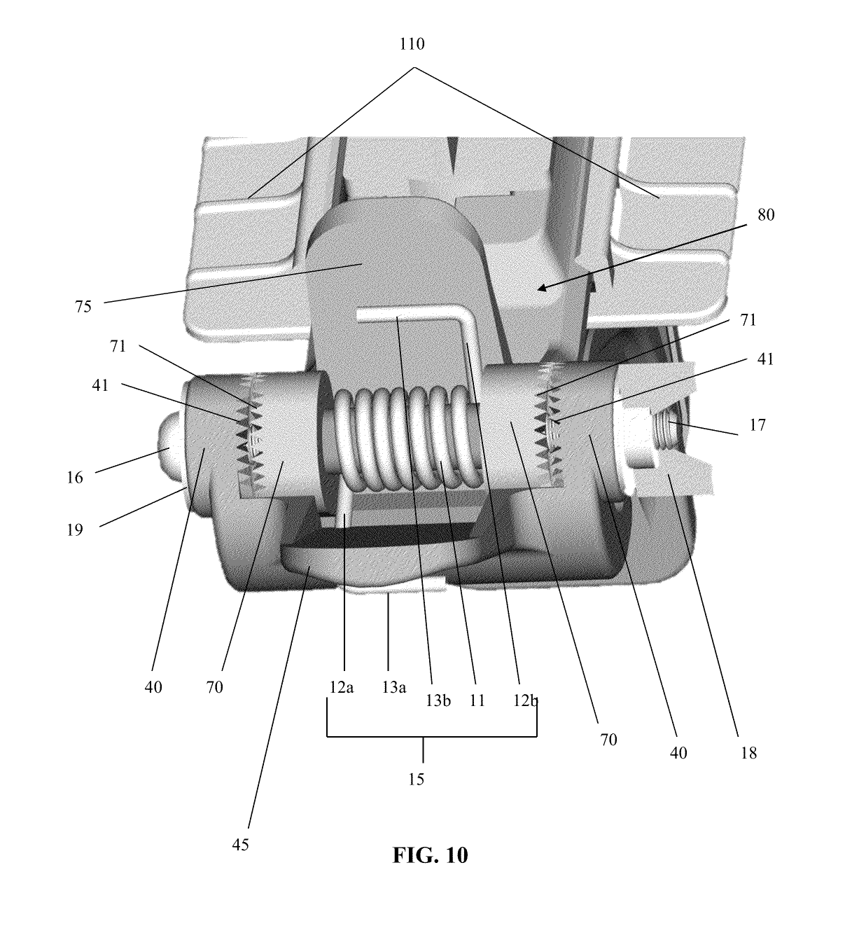

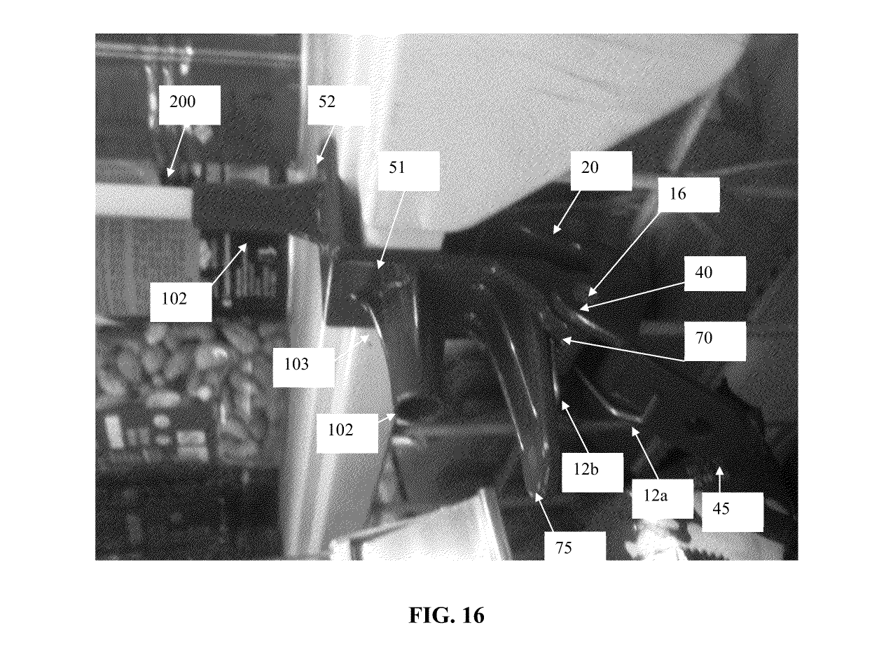

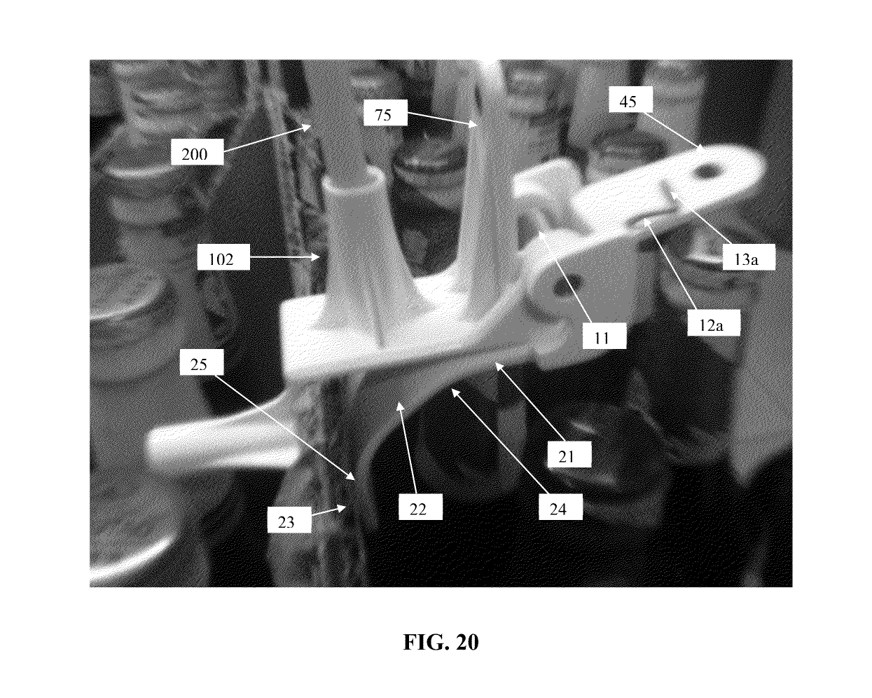

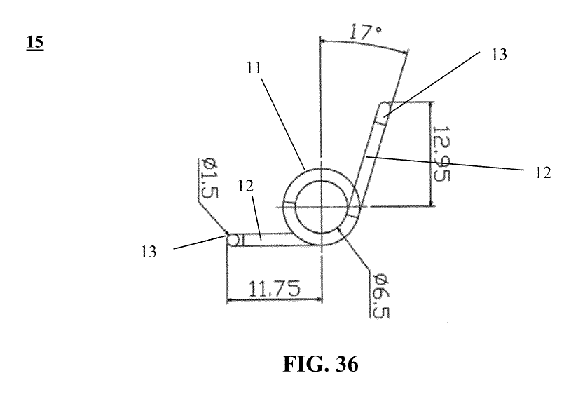

Referring to FIGS. 10, 16, 20, 35, and 36, in an embodiment, the spring member 15 can include a coil 11, arm portions 12 (e.g., 12a and 12b) extending from the coil 11, and bar portions 13 (e.g., 13a and 13b) extending from the arm portions 12). The arm portions 12 can include a first arm portion 12a extending towards the first jaw 20 and a second arm portion 12b extending towards the second jaw 50, though embodiments are not limited thereto. The bar portions can include a first bar portion 13a extending from the first arm portion 12a and in contact with the tab portion 45 of the first jaw 20 and a second bar portion 13b extending from the second arm portion 12b and in contact with the tab portion 75 of the second jaw 50, though embodiments are not limited thereto. Though FIG. 10 shows the first bar portion 12a below or on an opposite side of the tab portion 45 from the coil 11, the bar portion 13a should actually be on the inner surface of the tab portion 45 closer to the coil 11, as seen in FIGS. 16 and 20 and similar to the second bar portion 13b depicted in FIG. 10.

Referring again to FIG. 1, in an embodiment, the tab portion 45 of the first jaw 20 can have one or more protruding portions 48 on an inner surface thereof for stability and strength. Each protruding portion 48 can have a slanted, rail shape, e.g., a triangular or approximately triangular shape. The first portion 51 of the second jaw 50 can have one or more protruding portions 78 on an outer surface thereof for stability and strength. Each protruding portion 78 can have a slanted, rail shape, e.g., a triangular or approximately triangular shape.

In an embodiment, the first jaw 20 can include a backing 30 provided on an outer surface thereof, for example, on a surface of the first jaw 20 opposite the second flat portion 22, the first curved portion 24, the second curved portion 25, and/or the first flat portion 21. The backing can be made of, e.g., plastic, rubber, or metal, though embodiments are not limited thereto. In an embodiment, the backing 30 can be made of the same material as the remainder of the first jaw 20. In an alternative embodiment, the backing 30 can be made of a different material as the remainder of the first jaw 20.

In many embodiments, the first jaw 20 can have one or more connection portions 40 for providing a connection with the second jaw 50, such that the first 20 and second 50 jaws can be connected while the clamp is in use on a substrate. Each connection portions 40 can be, for example, approximately cylindrical in shape, as seen in the figures, though embodiments are not limited thereto. In an embodiment, a connection portion 40 can be provided on each side of the spring member 15. The second jaw 50 can have one or more connection portions 70 for providing a connection with the first jaw 20, such that the first 20 and second 50 jaws can be connected while the clamp is in use on a substrate. Each connection portions 70 can be, for example, approximately cylindrical in shape, as seen in the figures, though embodiments are not limited thereto. In an embodiment, a connection portion 70 can be provided on each side of the spring member 15.

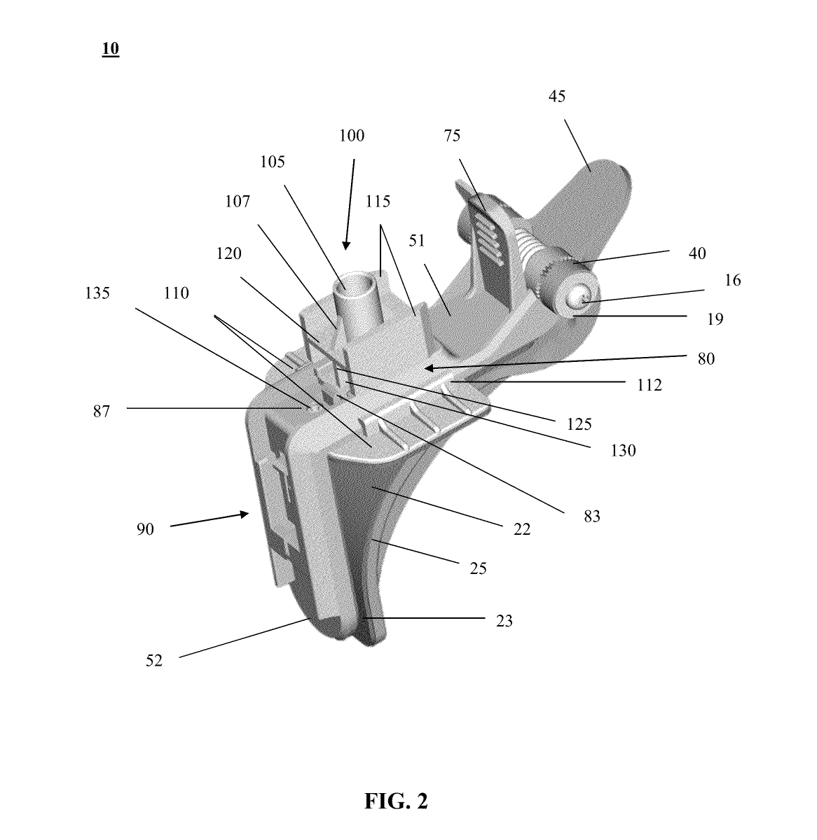

In an embodiment, a screw 17 can be provided through each connection member 40, 70 to connect the first jaw 20 and the second jaw 50. A nut 18 can be provided to help secure and/or tighten the screw 17 to help keep the clamp 10 in place when attached to a substrate (e.g., if a heavy item is attached to the clamp). The nut 18 can be, e.g., a hexagonal nut or a wing nut, though embodiments are not limited thereto. Referring to FIG. 2, in a particular embodiment, a washer 19 can be included between the head 16 of the screw 17 and the connection portion 40.

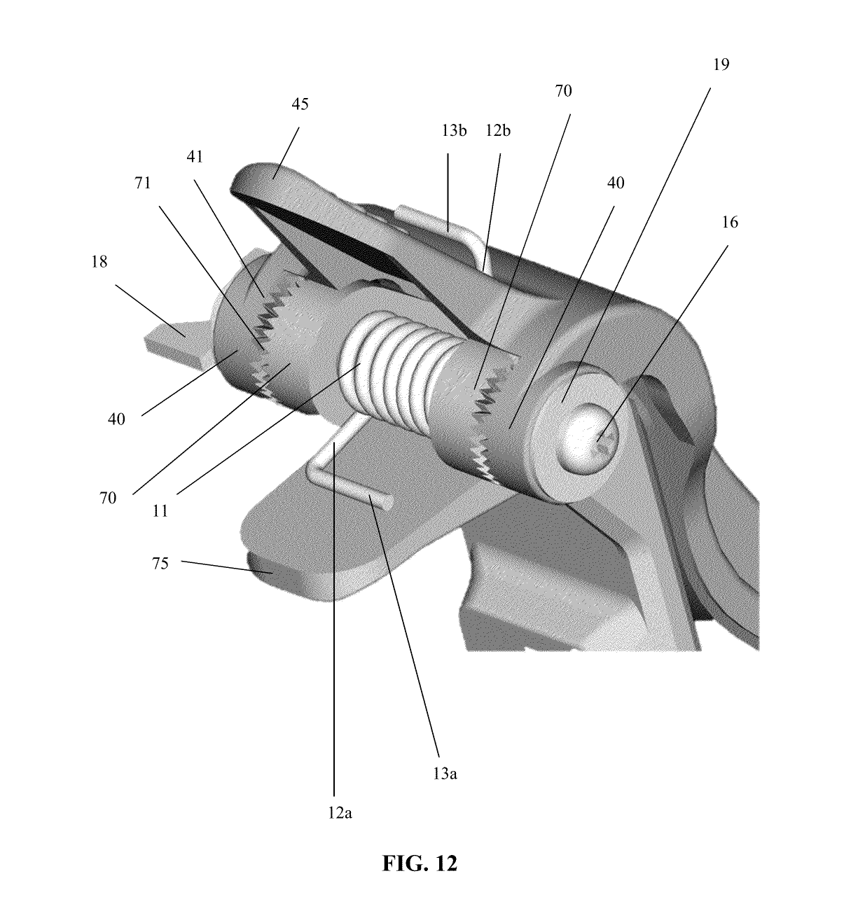

Referring to FIGS. 10 and 12, in an embodiment, a connection portion 40, 70 for each jaw can be provided on each side of the spring member 15 and can include teeth 41, 71. That is, each connection portion 40 of the first jaw 20 can include teeth 41, and each connection portion 70 of the second jaw 50 can include teeth 71. The teeth 41 of the connection portions 40 of the first jaw 20 can be configured to interlock with the teeth 71 of the connection portions 70 of the second jaw 50, and the teeth 71 of the connection portions 70 of the second jaw 50 can be configured to interlock with the teeth 41 of the connection portions 40 of the first jaw 20. In an embodiment, the teeth 41 and/or 71 can be angled such that the teeth 41 and/or 71 slant in a particular direction.

Referring again to FIG. 1, in an embodiment, the second jaw 50 can include one or more multipurpose connectors. For example, the first portion 51 of the second jaw 50 can include a first multipurpose connector 80, and/or the second portion 52 of the second jaw 50 can include a second multipurpose connector 90. The first multipurpose connector 80 can include first 81 and second 82 rails along lateral sides of the second jaw 50 and a horizontal portion 84 connecting the first 81 and second 82 rails. A gap portion 85 can be provided in the horizontal portion 84, though embodiments are not limited thereto. A securing protrusion 83 can be provided between the rails 81, 82 and protruding away from the inner surface of the second jaw 50, and one or more slits 86 can be provided between the securing protrusion 83 and the horizontal portion 84. In a particular embodiment, a receiving hole 87 can be provided between the securing protrusion 83 and the outer curved portion 65 of the second jaw 50.

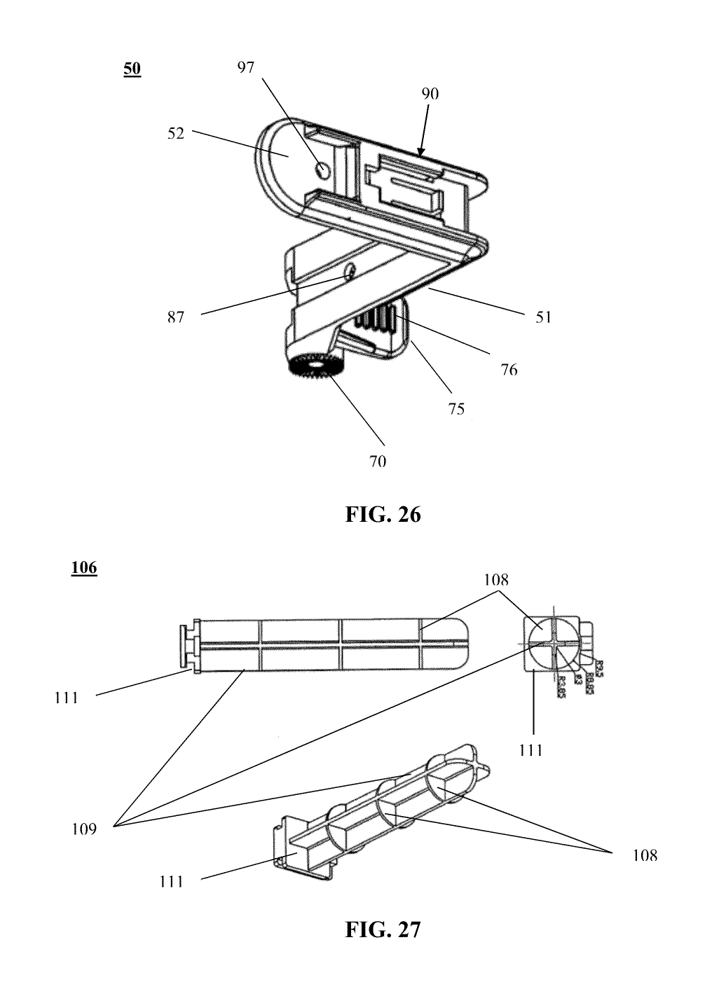

In an embodiment, the second portion 52 of the second jaw 50 can include a second multipurpose connector 90, and the second multipurpose connector 90 can include first 91 and second 92 rails along lateral sides of the second jaw 50 and a horizontal portion 94 connecting the first 91 and second 92 rails. The first 91 and second 92 rails can extend towards a distal end of the second jaw 50 beyond the horizontal portion 94, though embodiments are not limited thereto. A gap portion 95 can be provided in the horizontal portion 94, though embodiments are not limited thereto. A securing protrusion 93 can be provided between the rails 91, 92 and protruding away from the inner surface of the second jaw 50, and one or more slits 96 can be provided between the securing protrusion 93 and the horizontal portion 94. In a particular embodiment, a receiving hole 97 can be provided between the horizontal portion 94 and the distal end of the second jaw 50 (as seen in FIG. 26). In an embodiment, the second jaw 50 can include first 80 and second 90 multipurpose connectors, and the first 81 and second 82 rails of the first multipurpose connector 80 can extend into the outer curved portion 65 of the second jaw 50 and connect with the first 91 and second 92 rails, respectively, of the second multipurpose connector 90.

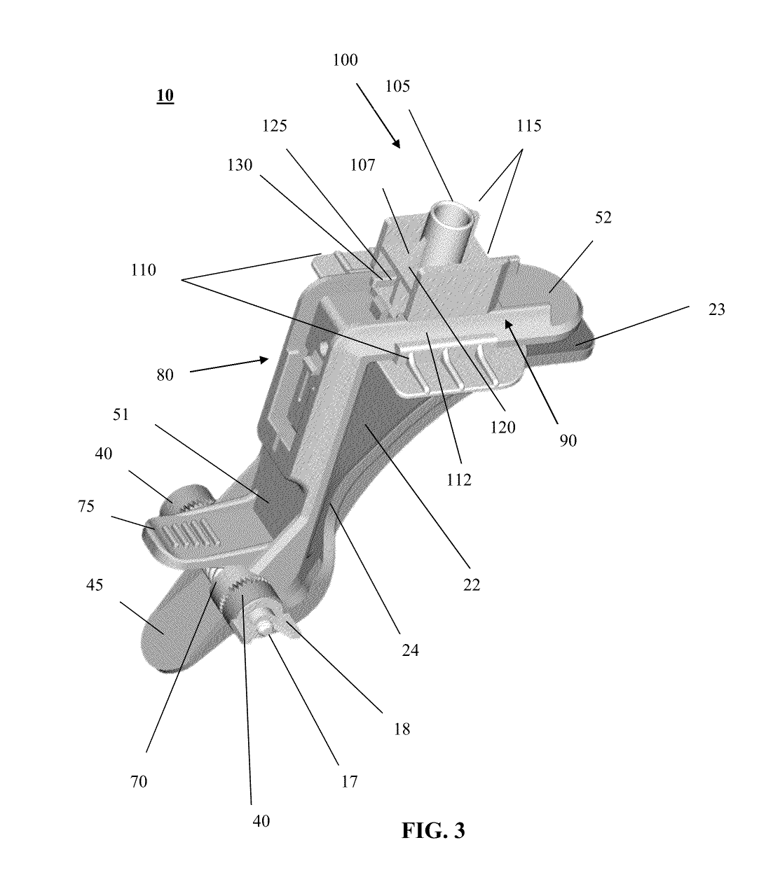

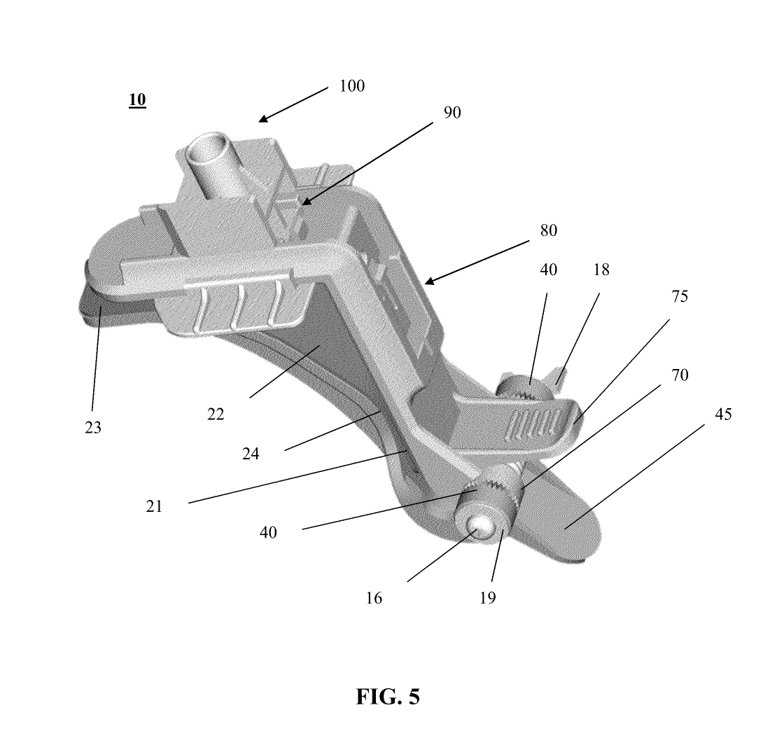

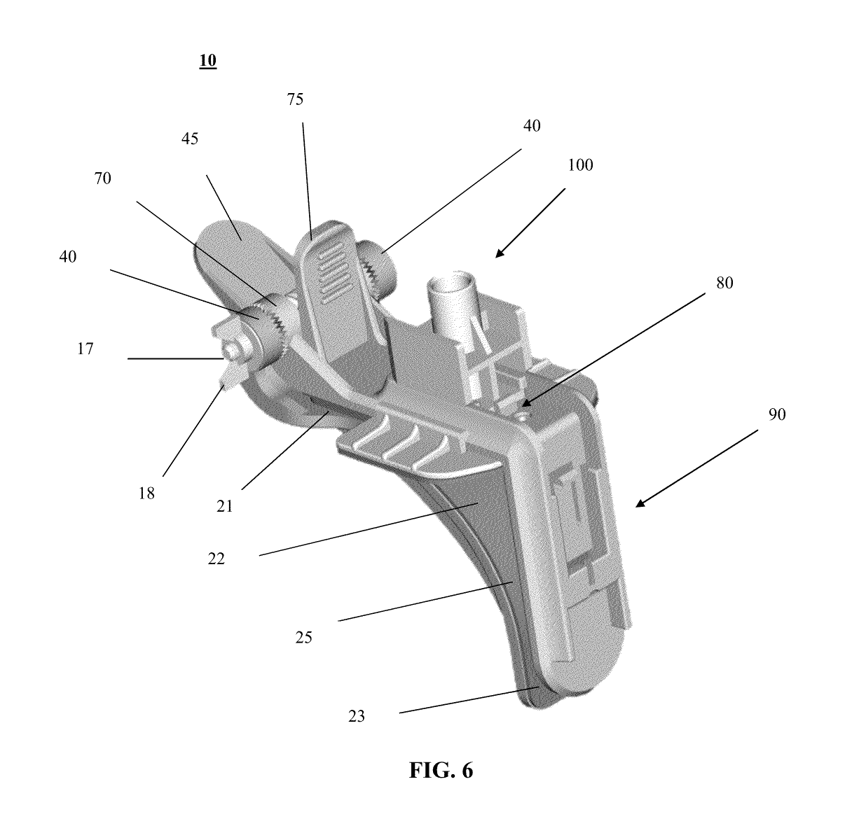

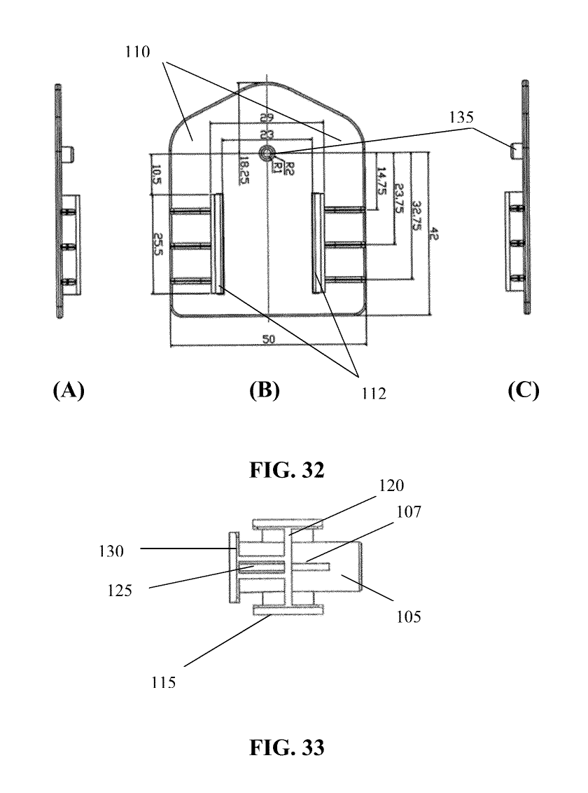

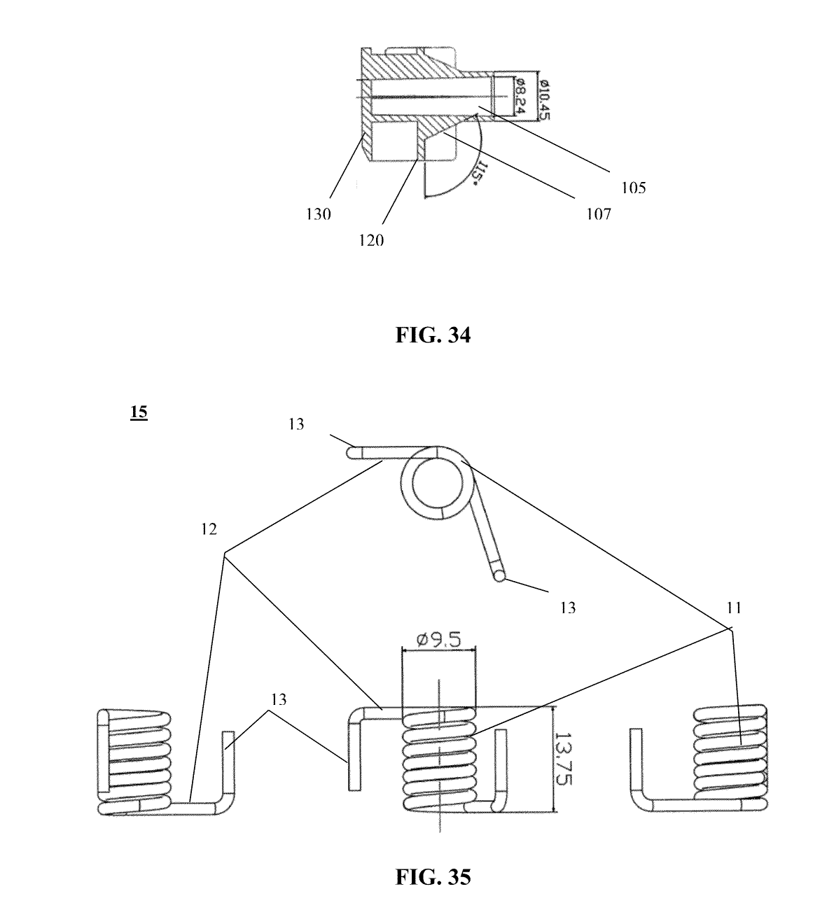

Referring to FIGS. 2, 3, 5, 6, 32A, 32B, 32C, and 33, in an embodiment, a rod attachment member 100 can be connected to a multipurpose connector 80, 90 of the second jaw 50. The rod attachment member 100 can include one or more of the following components: a base having one or more wings 110, a cylindrical receiving member 105, upper rails 115, a reinforcing member 107, an upper flat portion 120, a lower flat portion 130, a vertical member 125 connecting the upper flat portion 120 and the lower flat portion 130, and a cylindrical protrusion 135 protruding from the base. The wings 110, if present, can include lower rails 112 for gripping lateral sides of the second jaw 50. The reinforcing member 107, if present, can have, for example, a triangular or approximately triangular shape, and can help increase the strength of the rod attachment member 100. The lower flat portion 130, if present, and/or the vertical member 125, if present, can abut the securing protrusion (83, 93) of the second jaw 50 to inhibit sliding of the rod attachment member 100. The cylindrical protrusion 135, if present, can be received by the receiving hole (87, 97) in the second jaw 50 to secure the rod attachment member 100 in place.

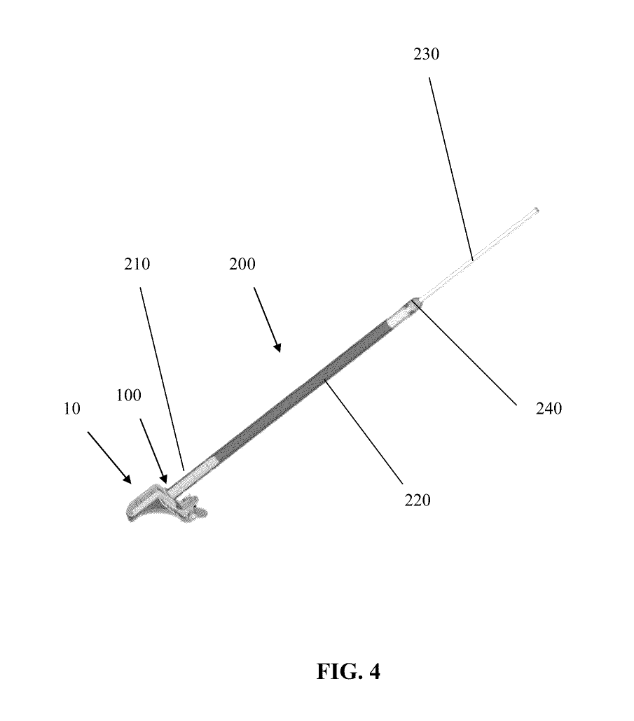

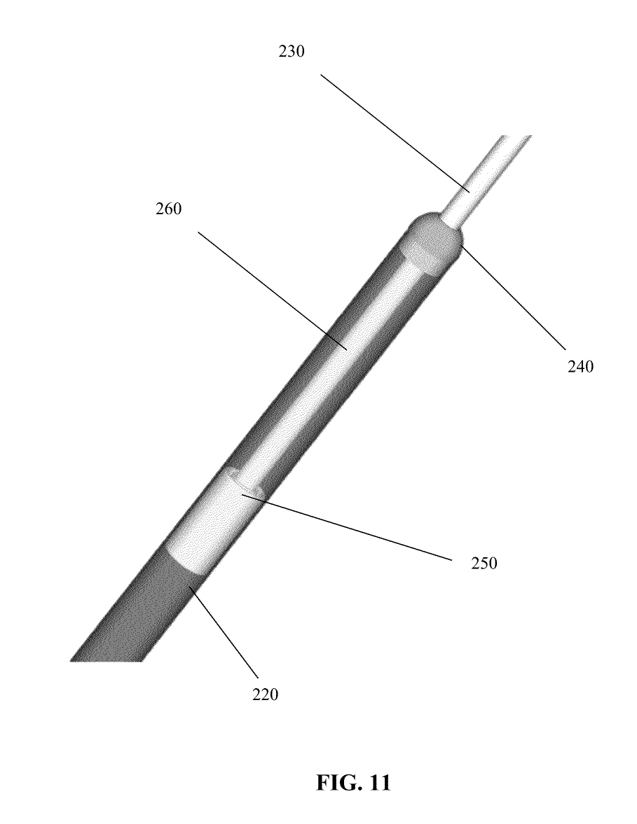

Referring to FIG. 4, in an embodiment, a rod attachment member 100 can be provided on a multipurpose connector 80, 90 of the second jaw 50, and a rod 200 can be attached to the rod attachment member 100. For example, the rod 200 can be inserted into the cylindrical receiving member 105 of the rod attachment member 100. In an embodiment, the rod 200 can include a lower portion 210, a middle portion 220, and an upper portion 230. The upper portion 230 can have a smaller diameter than the lower portion 210 and/or the middle portion 220. Also, the middle portion 220 can be connected to the upper portion 230 by a connection portion 240. Referring to FIG. 11, a portion 260 of the upper portion 230 can be contained within the middle portion 220. In addition, the upper portion 230 can be a telescoping rod, such that a stacking telescoping portion 250 is provided within the middle portion 220. The telescoping rod 230, 260 can advantageously extend upward, making the overall rod 200 length configurable depending on the desired purpose.

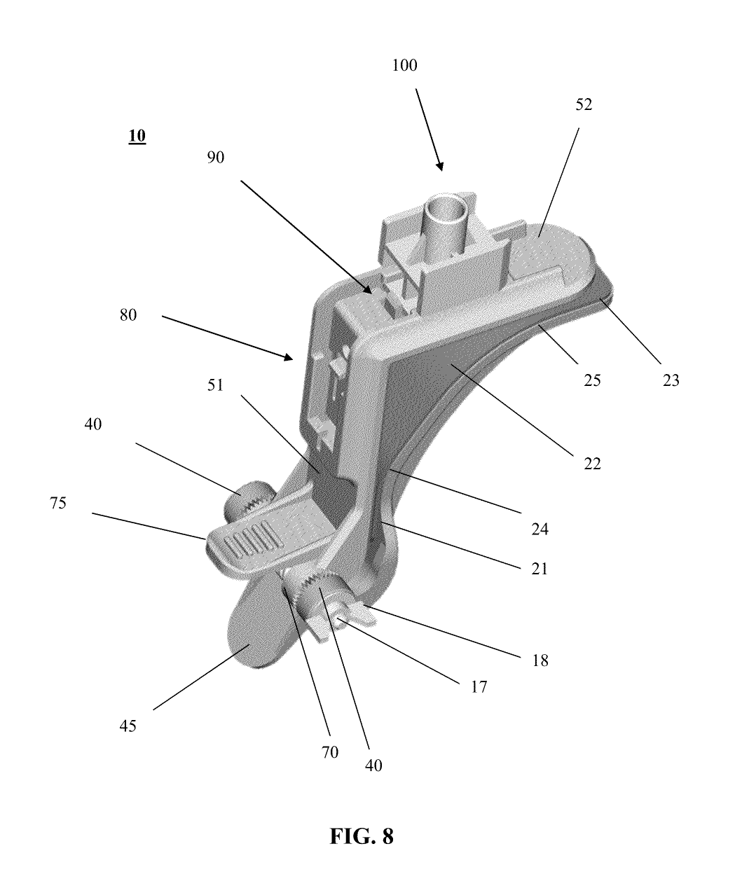

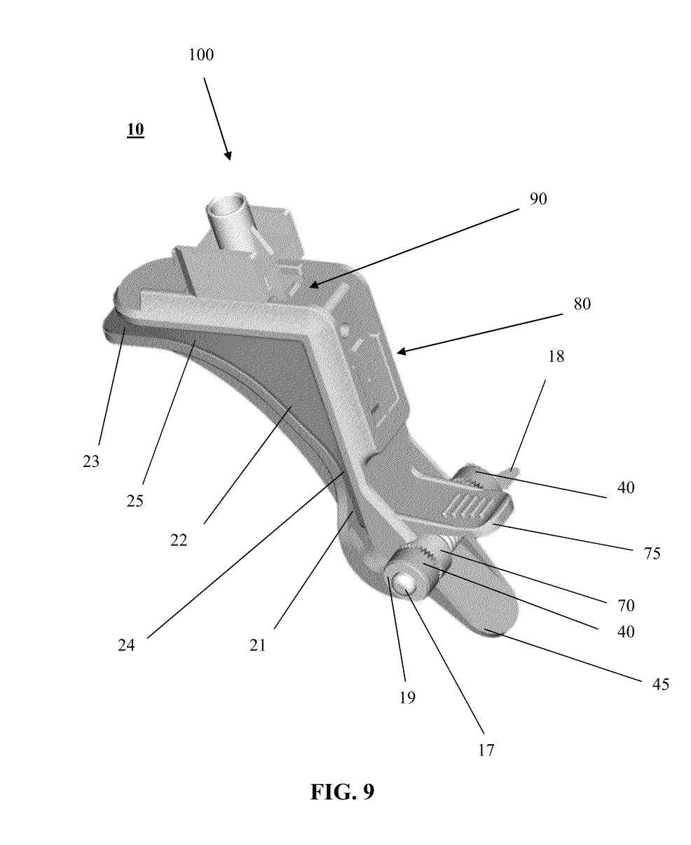

Referring to FIGS. 8 and 9, in an embodiment, a rod attachment member 100 can be connected to a multipurpose connector 80, 90 of the second jaw 50. The rod attachment member 100 can include no wings 110 or lower rails 112. The rod attachment member 100 can include one or more of the following components: a cylindrical receiving member 105, upper rails 115, a reinforcing member 107, an upper flat portion 120, a lower flat portion 130, a vertical member 125 connecting the upper flat portion 120 and the lower flat portion 130, and a cylindrical protrusion 135 protruding from the base. The reinforcing member 107, if present, can have, for example, a triangular or approximately triangular shape, and can help increase the strength of the rod attachment member 100. The lower flat portion 130, if present, and/or the vertical member 125, if present, can abut the securing protrusion (83, 93) of the second jaw 50 to inhibit sliding of the rod attachment member 100. The cylindrical protrusion 135, if present, can be received by the receiving hole (87, 97) in the second jaw 50 to secure the rod attachment member 100 in place.

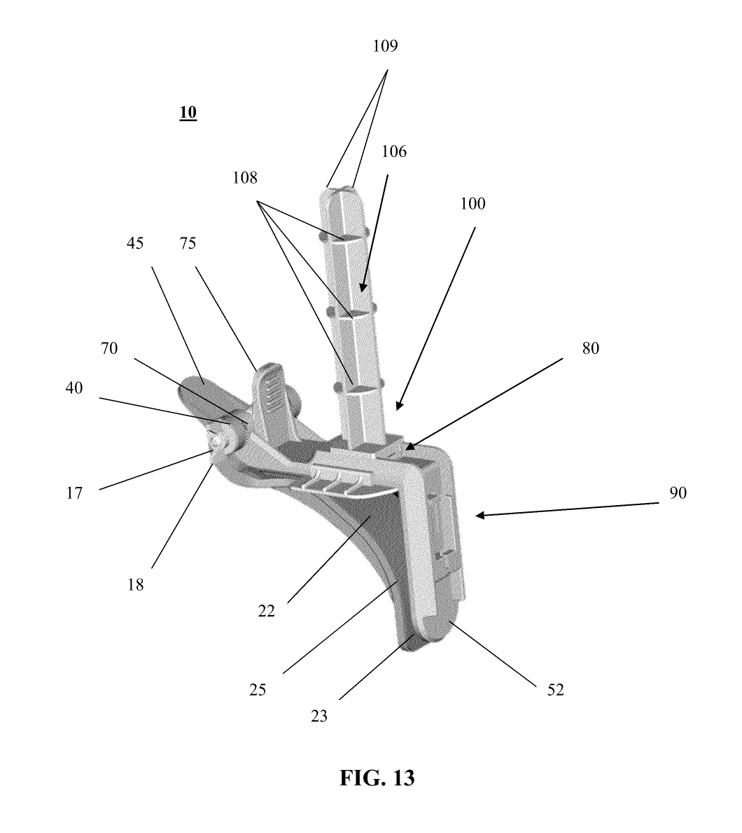

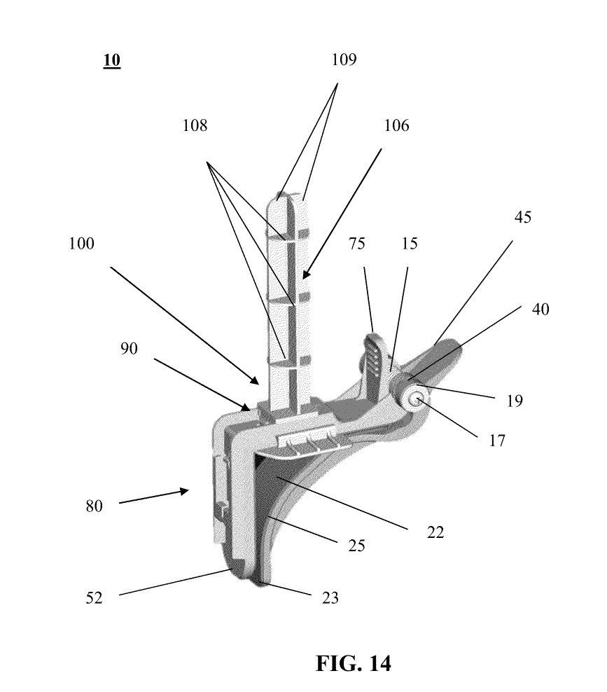

Referring to FIGS. 13, 14, and 27, in an embodiment, a rod attachment member 100 can be connected to a multipurpose connector 80, 90 of the second jaw 50 and can have a rod insertion member 106. The rod insertion member 106 can include base portion 111, one or more fin-type members 109 and one or more step members 108. The fin-type members 109 can extend vertically from the base portion 111 and can have, e.g., a cross-shape when viewed looking down onto the base portion 111. That is, the rod insertion member 106 can have four fin-type members 109 protruding up from the base portion 111 and radially away from a center axis of the rod insertion member 106 (which is perpendicular to the flat upper surface of the base portion 111), such that each fin-type member 109 is approximately perpendicular to both fin-type members 109 to which it is adjacent. The step members 108 can each be parallel to the upper surface of the base portion 111 and can connect two adjacent fin-type members 109. Four step members 108, when taken radially around the central axis of the rod insertion member 106, form a disc shape. In an embodiment, the rod insertion member 106 can include three such disc-shape step member 108 groups, or twelve total step members 108. The base portion 111 can include a lower portion, a flat upper surface, and one or more vertical members connecting the two, as seen in FIG. 27. The rod insertion member 106 can be used to, e.g., accept a rod inserted over the rod insertion member 106, and hold the rod in place.

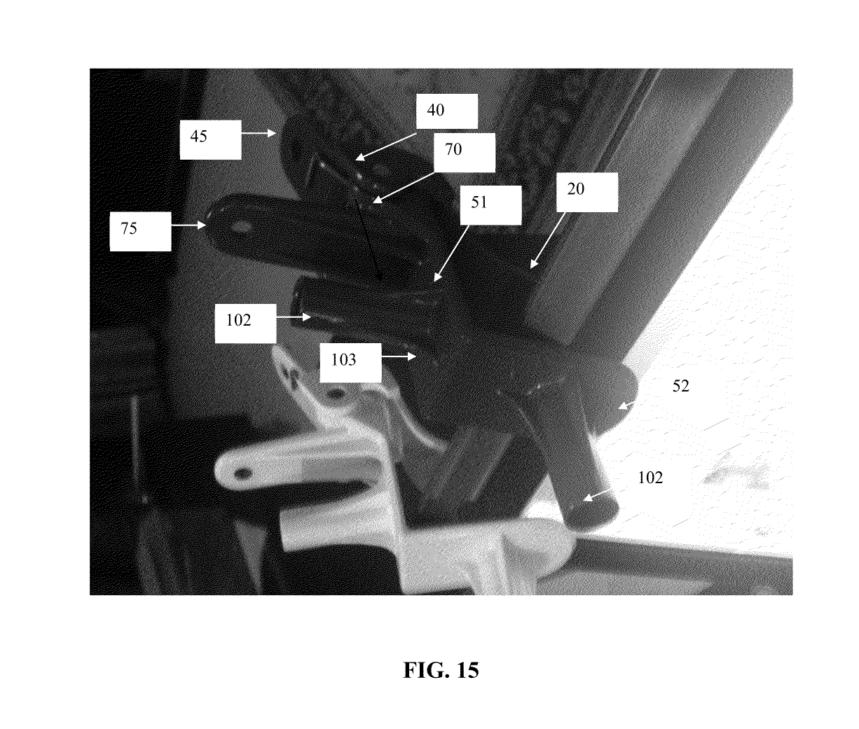

Referring to FIGS. 15-22, in an embodiment, one or more rod receiving members 102 can be homogenously formed with the second jaw 50. That is, one or more rod receiving members 102 can be integrally formed with the second jaw 50 (e.g., formed of the same material as the second jaw 50, during formation of the second jaw 50). A rod receiving member can be configured to receive a rod by, e.g., having a cylindrical or approximately cylindrical shape and including a cylindrical or approximately cylindrical hole for receiving a rod. For example, a rod receiving member 102 can be homogenously formed with the first portion 51 of the second jaw 50, or a rod receiving member 102 can be homogenously formed with the second portion 52 of the second jaw 50. In a particular embodiment, a rod receiving member 102 can be homogenously formed with the first portion 51 of the second jaw 50, and a rod receiving member 102 can be homogenously formed with the second portion 52 of the second jaw 50. In certain embodiments, a rod receiving member 102 can include one or more reinforcing portions 103 homogenously formed with the rod receiving member 102. For example, a rod receiving member 102 can include four reinforcing portions 103 formed around the outer edge of the rod receiving member 102 and approximately equally spaced around a circumference of the rod receiving member 102.

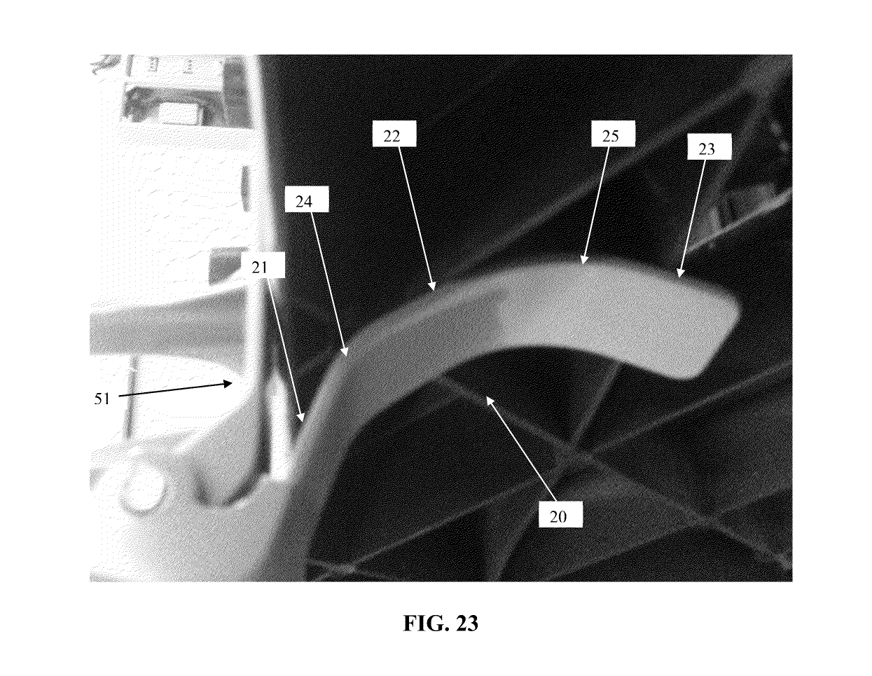

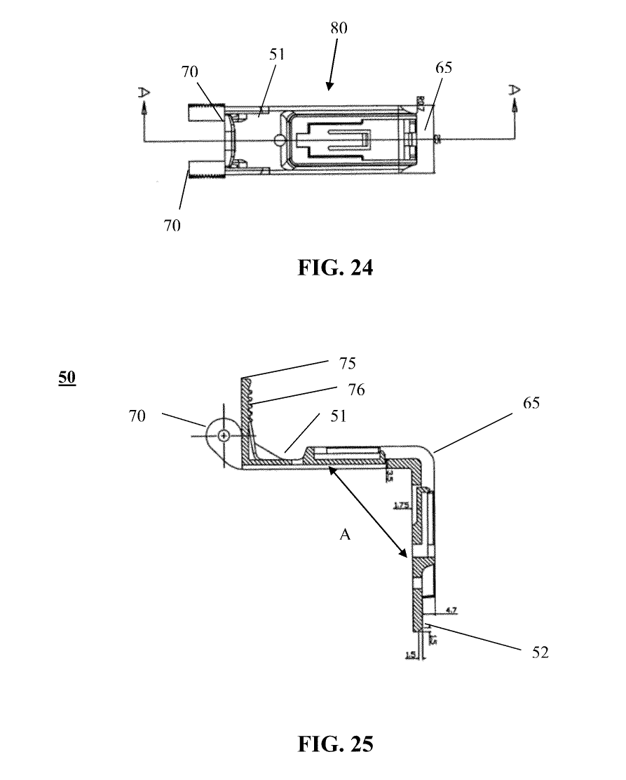

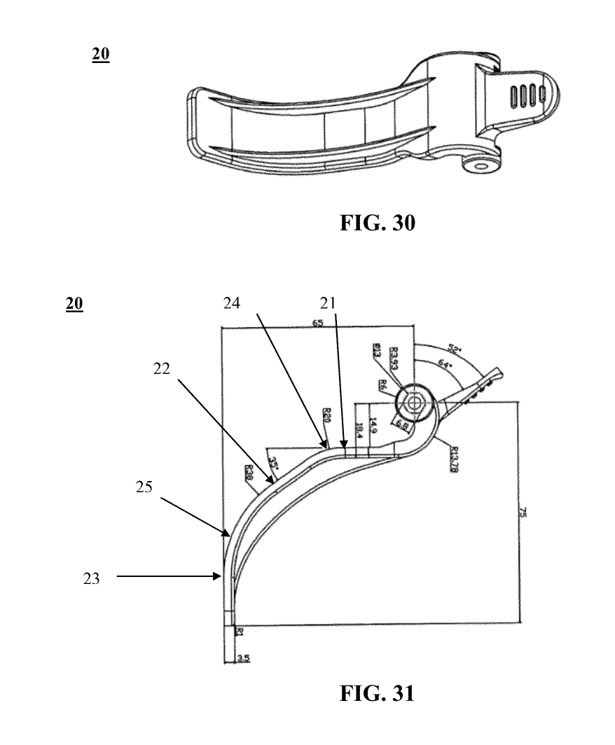

FIGS. 24, 25, and 26 show a top view, a cross-sectional side view, and a perspective view, respectively, of an embodiment of the second jaw 50. Referring to FIG. 25, the angle A between the first portion 51 and the second portion 52 of the second jaw 50 can be a right angle or approximately a right angle (i.e., can be 90 degrees or about 90 degrees). Such a configuration, in combination with the advantageous first jaw 20 described herein, allows for a clamp of the subject invention to securely grip substrates having a wide range of thicknesses relative to the size of the clamp, and inhibits the clamp from tilting, slipping, or losing grip, even when a heavy load is attached thereto. FIGS. 28, 29, 30, and 31 show a top view, a cross-sectional side view, a perspective view, and another cross-sectional side view, respectively, of an embodiment of the first jaw 20. Referring to FIGS. 29 and 31, the inner surface of the first jaw 20 can include three flat portions 21, 22, 23 with two smooth, curved portions 24, 25 provided between flat portions (i.e., the first flat portion 21 can be connected to the second flat portion 22 by the first curved portion 24, and the second flat portion 22 can be connected to the third flat portion 23 by the second curved portion 25).

As seen in FIG. 29, the tilt angle B between the first flat portion 21 and the second flat portion 22 is formed by the intersection of the plane in which the first flat portion 21 lies, represented by line F-F′, with the plane in which the second flat portion 22 lies, represented by line S-S′, measured by starting with the plane in which the first flat portion 21 lies and then tilting along the first curved portion 24 to the plane in which the second flat portion 22 lies. The tilt angle C between the second flat portion 22 and the third flat portion 23 is formed by the intersection of the plane in which the second flat portion 22 lies, represented by line S-S′, with the plane in which the third flat portion 23 lies, represented by line T-T′, measured by starting with the plane in which the second flat portion 22 lies and then tilting along the second curved portion 25 to the plane in which the third flat portion 23 lies. The tilt angle D between the first flat portion 21 and the third flat portion 23 is formed by the intersection of the plane in which the first flat portion 21 lies, represented by line F-F′, with the plane in which the third flat portion 22 lies, represented by line T-T′, measured by starting with the plane in which the first flat portion 21 lies and then tilting along the first curved portion 24 and the second curved portion 25 to the plane in which the third flat portion 23 lies.

The tilt angle B between the first flat portion 21 and the second flat portion 22 can be any of the following values or within any range having any of the following values as endpoints, though embodiments are not limited thereto (all numerical values are in degrees): 1, 2, 3, 4, 5, 10, 15, 20, 25, 26, 27, 28, 29, 30, 31, 32, 33, 34, 34.1, 34.2, 34.3, 34.4, 34.5, 34.6, 34.7, 34.8, 34.9, 35, 35.1, 35.2, 35.3, 35.4, 35.5, 35.6, 35.7, 35.8, 35.9, 36, 37, 38, 39, 40, 41, 42, 43, 44, 45, 50, 55, 60, 65, 70, 75, 80, 85, 90, about 1, about 2, about 3, about 4, about 5, about 10, about 15, about 20, about 25, about 26, about 27, about 28, about 29, about 30, about 31, about 32, about 33, about 34, about 34.1, about 34.2, about 34.3, about 34.4, about 34.5, about 34.6, about 34.7, about 34.8, about 34.9, about 35, about 35.1, about 35.2, about 35.3, about 35.4, about 35.5, about 35.6, about 35.7, about 35.8, about 35.9, about 36, about 37, about 38, about 39, about 40, about 41, about 42, about 43, about 44, about 45, about 50, about 55, about 60, about 65, about 70, about 75, about 80, about 85, about 90, at least 5, at least 10, at least 15, at least 20, at least 25, at least 30, at least 31, at least 32, at least 33, at least 34, at least 35, at least 36, at least 37, at least 38, at least 39, at least 40, at least 41, at least 42, at least 43, at least 44, at least 45, at least 50, at least 55, at least 60, at least 65, at least 70, at least 75, at least 80, at least 85, at least about 5, at least about 10, at least about 15, at least about 20, at least about 25, at least about 30, at least about 31, at least about 32, at least about 33, at least about 34, at least about 35, at least about 36, at least about 37, at least about 38, at least about 39, at least about 40, at least about 41, at least about 42, at least about 43, at least about 44, at least about 45, at least about 50, at least about 55, at least about 60, at least about 65, at least about 70, at least about 75, at least about 80, or at least about 85. For example, the tilt angle B between the first flat portion 21 and the second flat portion 22 can be in a range of about 10 degrees to about 50 degrees, in a range of about 15 degrees to about 45 degrees, in a range of about 20 degrees to about 40 degrees, in a range of about 25 degrees to about 35 degrees, or in a range of 30 degrees to 40 degrees. In an embodiment, the tilt angle B between the first flat portion 21 and the second flat portion 22 can be 35 degrees or about 35 degrees.

The tilt angle C between the second flat portion 22 and the third flat portion 23 can be any of the following values or within any range having any of the following values as endpoints, though embodiments are not limited thereto (all numerical values are in degrees): 1, 2, 3, 4, 5, 10, 15, 20, 25, 26, 27, 28, 29, 30, 31, 32, 33, 34, 34.1, 34.2, 34.3, 34.4, 34.5, 34.6, 34.7, 34.8, 34.9, 35, 35.1, 35.2, 35.3, 35.4, 35.5, 35.6, 35.7, 35.8, 35.9, 36, 37, 38, 39, 40, 41, 42, 43, 44, 45, 50, 55, 60, 65, 70, 75, 80, 85, 90, about 1, about 2, about 3, about 4, about 5, about 10, about 15, about 20, about 25, about 26, about 27, about 28, about 29, about 30, about 31, about 32, about 33, about 34, about 34.1, about 34.2, about 34.3, about 34.4, about 34.5, about 34.6, about 34.7, about 34.8, about 34.9, about 35, about 35.1, about 35.2, about 35.3, about 35.4, about 35.5, about 35.6, about 35.7, about 35.8, about 35.9, about 36, about 37, about 38, about 39, about 40, about 41, about 42, about 43, about 44, about 45, about 50, about 55, about 60, about 65, about 70, about 75, about 80, about 85, about 90, at least 5, at least 10, at least 15, at least 20, at least 25, at least 30, at least 31, at least 32, at least 33, at least 34, at least 35, at least 36, at least 37, at least 38, at least 39, at least 40, at least 41, at least 42, at least 43, at least 44, at least 45, at least 50, at least 55, at least 60, at least 65, at least 70, at least 75, at least 80, at least 85, at least about 5, at least about 10, at least about 15, at least about 20, at least about 25, at least about 30, at least about 31, at least about 32, at least about 33, at least about 34, at least about 35, at least about 36, at least about 37, at least about 38, at least about 39, at least about 40, at least about 41, at least about 42, at least about 43, at least about 44, at least about 45, at least about 50, at least about 55, at least about 60, at least about 65, at least about 70, at least about 75, at least about 80, or at least about 85. For example, the tilt angle C between the second flat portion 22 and the third flat portion 23 can be in a range of about 10 degrees to about 50 degrees, in a range of about 15 degrees to about 45 degrees, in a range of about 20 degrees to about 40 degrees, in a range of about 25 degrees to about 35 degrees, or in a range of 30 degrees to 40 degrees. In an embodiment, the tilt angle C between the second flat portion 22 and the third flat portion 23 can be 35 degrees or about 35 degrees. In embodiments having two flat portions or four or more flat portions, the tilt angle between any two adjacent flat portions can be any of the values or within any of the ranges as disclosed for tilt angles B or C.

The tilt angle D between the first flat portion 21 and the third flat portion 23 can be any of the following values or within any range having any of the following values as endpoints, though embodiments are not limited thereto (all numerical values are in degrees): 1, 2, 3, 4, 5, 10, 15, 20, 25, 26, 27, 28, 29, 30, 35, 40, 45, 50, 55, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 115, 120, 125, 130, 135, 140, about 1, about 2, about 3, about 4, about 5, about 10, about 15, about 20, about 25, about 26, about 27, about 28, about 29, about 30, about 35, about 40, about 45, about 50, about 55, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, about 101, about 102, about 103, about 104, about 105, about 106, about 107, about 108, about 109, about 110, about 115, about 120, about 125, about 130, about 135, about 140, at least 1, at least 2, at least 3, at least 4, at least 5, at least 10, at least 15, at least 20, at least 25, at least 26, at least 27, at least 28, at least 29, at least 30, at least 35, at least 40, at least 45, at least 50, at least 55, at least 60, at least 61, at least 62, at least 63, at least 64, at least 65, at least 66, at least 67, at least 68, at least 69, at least 70, at least 71, at least 72, at least 73, at least 74, at least 75, at least 76, at least 77, at least 78, at least 79, at least 80, at least 81, at least 82, at least 83, at least 84, at least 85, at least 86, at least 87, at least 88, at least 89, at least 90, at least 91, at least 92, at least 93, at least 94, at least 95, at least 96, at least 97, at least 98, at least 99, at least 100, at least 101, at least 102, at least 103, at least 104, at least 105, at least 106, at least 107, at least 108, at least 109, at least 110, at least 115, at least 120, at least 125, at least about 1, at least about 2, at least about 3, at least about 4, at least about 5, at least about 10, at least about 15, at least about 20, at least about 25, at least about 26, at least about 27, at least about 28, at least about 29, at least about 30, at least about 35, at least about 40, at least about 45, at least about 50, at least about 55, at least about 60, at least about 61, at least about 62, at least about 63, at least about 64, at least about 65, at least about 66, at least about 67, at least about 68, at least about 69, at least about 70, at least about 71, at least about 72, at least about 73, at least about 74, at least about 75, at least about 76, at least about 77, at least about 78, at least about 79, at least about 80, at least about 81, at least about 82, at least about 83, at least about 84, at least about 85, at least about 86, at least about 87, at least about 88, at least about 89, at least about 90, at least about 91, at least about 92, at least about 93, at least about 94, at least about 95, at least about 96, at least about 97, at least about 98, at least about 99, at least about 100, at least about 101, at least about 102, at least about 103, at least about 104, at least about 105, at least about 106, at least about 107, at least about 108, at least about 109, at least about 110, at least about 115, at least about 120, at least about 125, less than 90, less than 95, less than 100, less than 105, less than 110, less than 115, less than 120, less than 125, less than 130, less than 135, less than 140, less than 145, less than 150, less than 155, less than 160, less than 165, less than 170, less than about 90, less than about 95, less than about 100, less than about 105, less than about 110, less than about 115, less than about 120, less than about 125, less than about 130, less than about 135, less than about 140, less than about 145, less than about 150, less than about 155, less than about 160, less than about 165, or less than about 170. For example, the tilt angle D between the first flat portion 21 and the third flat portion 23 can be in a range of about 20 degrees to about 100 degrees, in a range of about 30 degrees to about 90 degrees, in a range of about 40 degrees to about 80 degrees, in a range of about 50 degrees to about 70 degrees, or in a range of 60 degrees to 80 degrees. In an embodiment, the tilt angle C between the second flat portion 22 and the third flat portion 23 can be 70 degrees or about 70 degrees.

A clamp having a jaw portion with a plurality of flat portions (e.g., 21, 22, and 23) connected to each other by curved portions (e.g., 24 and 25) can advantageously increase the surface area contact between the jaw portion and the substrate to which it is affixed in use. Thus, the clamp 10 “finds the corner,” meaning that the inner surface of the jaw portion having a plurality of flat portions contacts the substrate in an advantageous manner, increasing the stability of the clamp, even when large loads are attached thereto, and inhibiting tilting and slipping.

A clamp of the subject invention can advantageously grip substrates having a wide range of thicknesses without losing any strength or stability, even when a load (e.g., a rod having a sign or a non-helium balloon assembly) attached to it. A clamp of the subject invention can also include a nut 18, such as a wing nut, which can be tightened to further stabilize the clamp and hold together the connection portions 40, 70 of the first 20 and second 50 jaws. In addition, the connection portions 40, 70 can have teeth 41, 71 which can interlock to even further stabilize the clamp and hold together the connection portions 40, 70 of the first 20 and second 50 jaws. This effect is enhanced when a nut 18 is used in conjunction with interlocking teeth.

Though the figures show clamps having multipurpose connectors and/or rod receiving members on the first and/or second portions of the second jaw, embodiments of the subject invention are not limited thereto. In an embodiment, the first portion of the second jaw, the second portion of the second jaw, or both can have no such connector or member. For example, the outer surface (i.e., the surface that does not face the first jaw) of any or all portions of the second jaw can be flat or essentially flat or can have other connectors or members formed thereon.

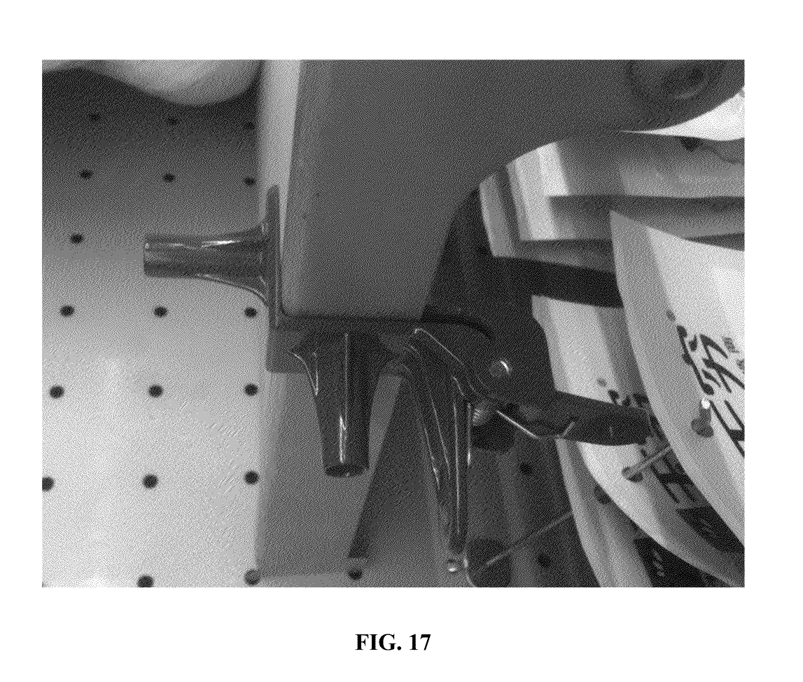

FIGS. 15-23 show images of embodiments of clamps of the subject invention gripping substrates of various sizes, shapes, and materials. Referring to FIG. 15, a clamp easily grips the frame of a picture frame assembly. Referring to FIG. 16, a clamp comfortably grips the edge of a shelf while having a rod 200 attached to it. Referring to FIG. 17, a clamp once again comfortably grips the edge of a differently-sized shelf Referring to FIG. 18, the large contact area generated between the clamp and the substrate can be seen; this is as a result of the advantageous shape of the first jaw. In this example, even though the substrate is relatively narrow compared to the size of the clamp, the third flat portion 23 makes good contact with the substrate, thereby ensuring high friction and strong clamping, and inhibiting tilting, slipping, or losing grip.

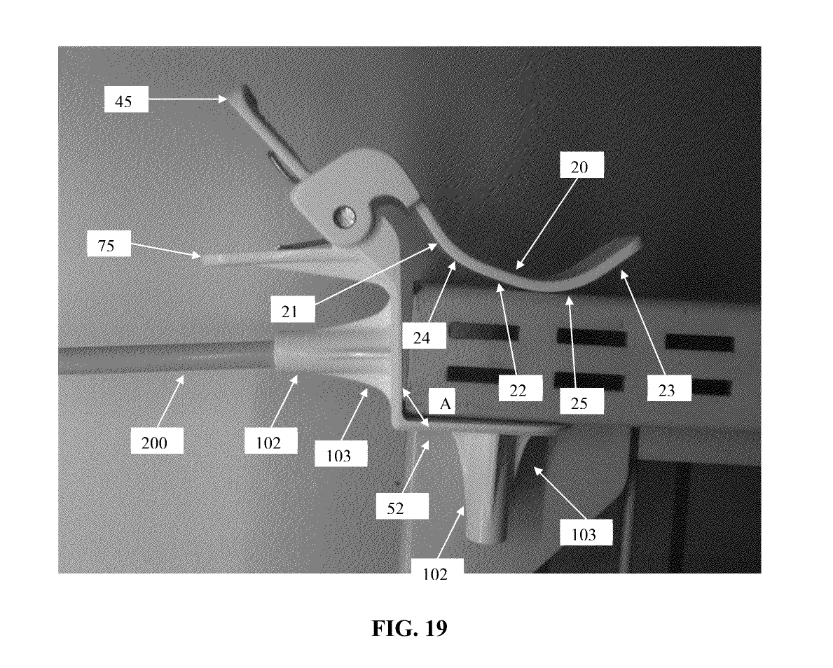

Referring to FIG. 19, a clamp can be seen comfortably gripping a substrate that it is an odd thickness compared to the size of the clamp. Due to the advantageous shape of the first jaw, the smooth, gradual curve of the second curved portion 25 ensures a large amount of surface area contact between the first jaw and the substrate to which it is clamped, whereas a sharp edge between flat portions would decrease the surface area contact between the first jaw and this substrate. This helps the second jaw “find the corner” where the first portion meets the second portion 52, even though there is a load attached (rod 200). Referring to FIG. 20, the clamp comfortably grips even an extremely narrow substrate, providing a large amount of surface contact area between the third surface 23 and the narrow, cardboard substrate.

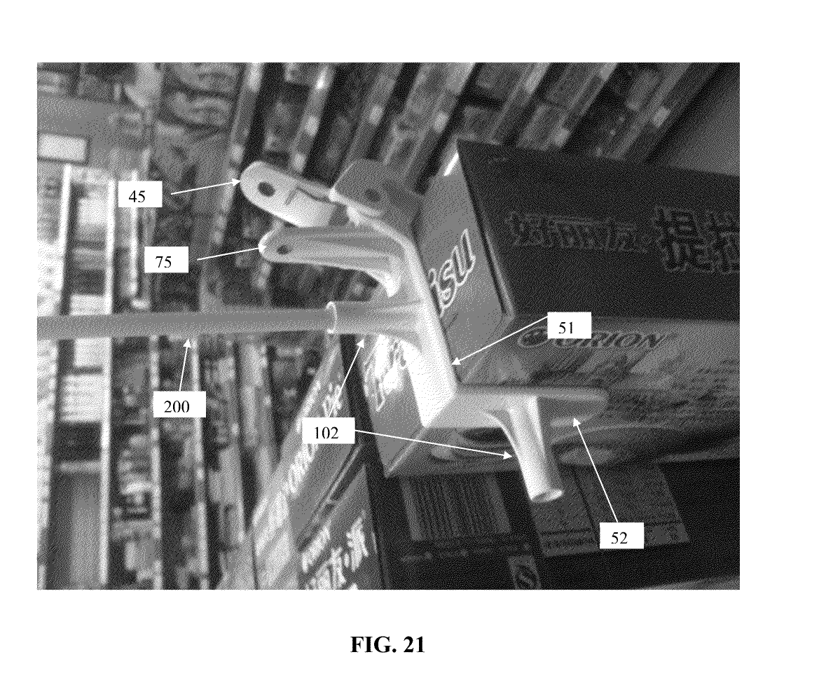

Referring to FIG. 21, a clamp easily grips a substrate that is very thick relative to the clamp size and much, much thicker than the substrate in FIG. 20. The advantageous shape of the first jaw ensures a large amount of surface contact area and once again helps the second jaw “find the corner” where the first portion 51 meets the second portion 52, even though there is a load attached (rod 200).

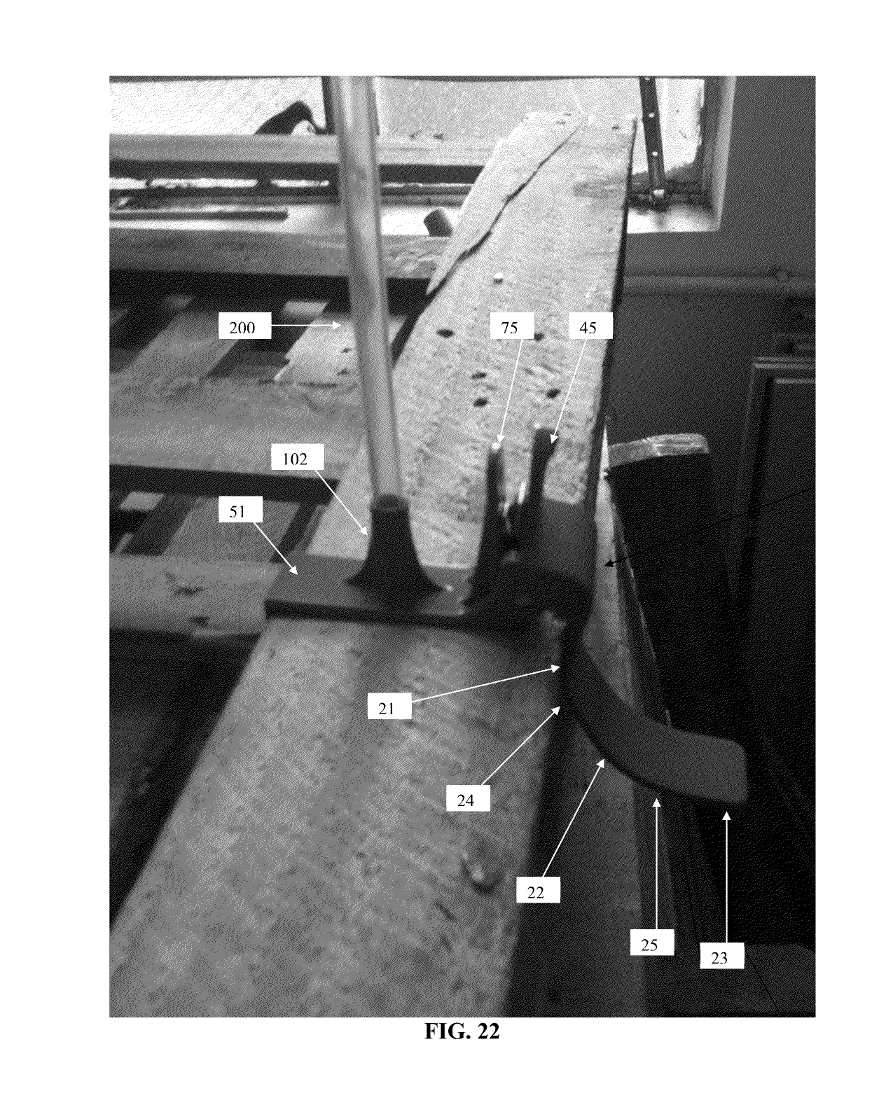

Referring to FIG. 22, a clamp comfortably grips an extremely thick and rigid substrate (a piece of wood) that is much larger than the substrate of FIG. 20. Due to the advantageous shape of the first jaw, the first flat portion 21 is able to generate a large amount of surface contact between the first jaw and the substrate to which it is clamped.

Referring to FIG. 23, a clamp grips a substrate that has gaps and protrusions where the first jaw makes contact. However, again due to the advantageous shape of the first jaw, a large amount of surface contact is generated between the first jaw and the substrate. In this case, multiple portions of the first jaw make contact with the substrate, providing excellent stability to the clamp.

Referring again to FIGS. 15-17 and 19-22, the advantageous shape of the first jaw helps the second jaw “find the corner” on the substrate where the first portion 51 meets the second portion 52, even if there is a load attached. This further enhances the stability of the clamp, inhibiting tilting, slipping, or loss of grip.

A clamp of the subject invention can be configured to advantageously grip substrates having a wide range of thicknesses. A clamp can be configured to grip a substrate having a thickness of any of the following values or within any range having any of the following values as endpoints, though embodiments are not limited thereto (all numerical values are in millimeters): 0.5, 1, 2, 3, 4, 5, 6, 7, 8, 9, 10, 15, 20, 25, 25.4 (1 inch), 30, 35, 40, 45, 50, 50.8 (2 inches), 55, 60, 65, 70, 75, 76.2 (3 inches), 80, 85, 90, 95, 100, 101.6 (4 inches), 105, 110, 115, 120, 125, 127 (5 inches), 130, 135, 140, 145, 150, 152.4 (6 inches), 155, 160, 165, 170, 175, 177.8 (7 inches), 180, 185, 190, 200, 203.2 (8 inches), 205, 210, 215, 220, 225, 228.6 (9 inches), 230, 235, 240, 245, 250, 254 (10 inches), 255, 260, 265, 270, 275, 279.4 (11 inches), 280, 285, 290, 295, 300, 304.8 (12 inches), 305, 310, 315, 320, 325, 330.2 (13 inches), 335, 340, 345, 350, 355, 355.6 (14 inches), 375, 381 (15 inches), 400, 406.4 (16 inches), 425, 431.8 (17 inches), 450, 457.2 (18 inches), 475, 482.6 (19 inches), 500, 508 (20 inches), 525, 533.4 (21 inches), 550, 558.8 (22 inches), 575, 584.2 (23 inches), 600, 609.6 (24 inches), about 0.5, about 1, about 2, about 3, about 4, about 5, about 6, about 7, about 8, about 9, about 10, about 15, about 20, about 25, about 25.4 (1 inch), about 30, about 35, about 40, about 45, about 50, about 50.8 (2 inches), about 55, about 60, about 65, about 70, about 75, about 76.2 (3 inches), about 80, about 85, about 90, about 95, about 100, about 101.6 (4 inches), about 105, about 110, about 115, about 120, about 125, about 127 (5 inches), about 130, about 135, about 140, about 145, about 150, about 152.4 (6 inches), about 155, about 160, about 165, about 170, about 175, about 177.8 (7 inches), about 180, about 185, about 190, about 200, about 203.2 (8 inches), about 205, about 210, about 215, about 220, about 225, about 228.6 (9 inches), about 230, about 235, about 240, about 245, about 250, about 254 (10 inches), about 255, about 260, about 265, about 270, about 275, about 279.4 (11 inches), about 280, about 285, about 290, about 295, about 300, about 304.8 (12 inches), about 305, about 310, about 315, about 320, about 325, about 330.2 (13 inches), about 335, about 340, about 345, about 350, about 355, about 355.6 (14 inches), about 375, about 381 (15 inches), about 400, about 406.4 (16 inches), about 425, about 431.8 (17 inches), about 450, about 457.2 (18 inches), about 475, about 482.6 (19 inches), about 500, about 508 (20 inches), about 525, about 533.4 (21 inches), about 550, about 558.8 (22 inches), about 575, about 584.2 (23 inches), about 600, or about 609.6 (24 inches). For example, a clamp can be configured to grip any substrate having a thickness in a range of from about 1 millimeter (mm) to about 4 inches (in). In certain embodiments, a clamp can “find the corner” between the second jaw (where the first portion meets the second portion) and the substrate for any thickness for which it is configured, though embodiments are not limited thereto.

A clamp according to the subject invention can be any suitable color. For example, a clamp can be white, black, blue, red, green, yellow, orange, purple, pink, gray, silver, or gold, though embodiments are not limited thereto.

In an embodiment, a method of forming a clamp can include forming a first jaw, forming a second jaw, and connecting the first jaw to the second jaw. The method can further include connecting a spring member to the first and second jaws. The first jaw and the second jaw can be as described herein, and can have any or all of the features described herein. The first jaw and the second jaw can each be made of any suitable material known in the art. For example, the first jaw and the second jaw can each be made of metal, plastic, rubber, or any combination thereof, though embodiments are not limited thereto. In an embodiment, the first jaw and the second jaw can be made using a molding process. In an embodiment, the first jaw and the second jaw can be formed of the same material. In an alternative embodiment, the first jaw and the second jaw can be formed of different materials.

In an embodiment, the first jaw and the second jaw can each have at least one connection part. The connection parts can be as described herein, and can have any or all features described herein. Connecting the first jaw to the second jaw can include connection the at least one connection part of the first jaw to the at least one connection part of the second jaw. For example, connecting the first jaw to the second jaw can include inserting a screw through the at least one connection part of the first jaw and the at least one connection part of the second jaw. In an embodiment, the screw can be fastened with a nut (e.g., a wing nut or a hexagonal nut).

The spring member can be as described herein, and can include any or all features described herein. In an embodiment, connecting the first jaw to the second jaw can include inserting a screw through the at least one connection part of the first jaw, the spring member (e.g., a coil of the spring member), and the at least one connection part of the second jaw. In an embodiment, the screw can be fastened with a nut (e.g., a wing nut or a hexagonal nut). The spring member can be positioned such that a portion of it (e.g., a bar portion connected to a coil by an arm member) is in contact with a portion (e.g., a tab portion) of the first jaw and applying force thereto, and a portion of the spring member (e.g., a bar portion connected to a coil by an arm member) is in contact with a portion (e.g., a tab portion) of the second jaw and applying force thereto. The spring member can be applying force to an inner surface of the first jaw (e.g., an inner surface of a tab portion of the first jaw) and an inner surface of the second jaw (e.g., an inner surface of a tab portion of the second jaw). The inner surface of each jaw is the surface that faces the other jaw.

In embodiment, a method of affixing an object to a substrate can include affixing a clamp to the substrate and attaching the object to the clamp. The clamp can be as described herein, and can include any and all features described herein. The object can be attached to the clamp through any suitable means. In an embodiment, an object can be attached to the clamp using a multipurpose connector on a surface of the clamp. In a particular embodiment, an object (e.g., a rod, or a rod portion of an object having a rod portion) can be attached to the clamp using a rod receiving member. The rod receiving member can be homogenously formed with at least a portion of the clamp. For example, the rod receiving member can be homogenously formed with a second jaw (as described herein) of the clamp. In an embodiment, an object can be attached to the clamp by being hanged from the clamp or inserted between the clamp and the substrate. An object can also be attached to the clamp using other known affixing means, including but not limited to tape, glue, string, rope, twist ties, zip ties, rubber bands, and paper clips.

### Exemplified Embodiments

The invention includes, but is not limited to, the following embodiments:

### Embodiment 1

A clamp, comprising:
a first jaw;
a second jaw connected to the first jaw; and
a spring member configured to push the first jaw towards the second jaw,
wherein the first jaw comprises an inner surface having a first flat portion, a second flat portion, and a third flat portion,
wherein the first flat portion is connected to the second flat portion by a first curved portion, and
wherein the second flat portion is connected to the third flat portion by a second curved portion.

### Embodiment 2

The clamp according to embodiment 1, wherein the second jaw comprises:
a second tab portion;
a first portion proximal to the second tab portion and having a substantially flat inner surface; and
a second portion distal to the second tab portion and having a substantially flat inner surface.

### Embodiment 3

The clamp according to embodiment 2, wherein an angle between the inner surface of the first portion and the inner surface of the second portion is in a range of from 70 degrees to 110 degrees.

### Embodiment 4

The clamp according to embodiment 2, wherein an angle between the inner surface of the first portion and the inner surface of the second portion is in a range of from 85 degrees to 95 degrees.

### Embodiment 5

The clamp according to embodiment 2, wherein an angle between the inner surface of the first portion and the inner surface of the second portion is about 90 degrees.

### Embodiment 6

The clamp according to embodiment 2, wherein an angle between the inner surface of the first portion and the inner surface of the second portion is in a range of from 89 degrees to 91 degrees.

### Embodiment 7

The clamp according to embodiment 2, wherein an angle between the inner surface of the first portion and the inner surface of the second portion is in a range of from 89.5 degrees to 90.5 degrees.

### Embodiment 8

The clamp according to embodiment 2, wherein an angle between the inner surface of the first portion and the inner surface of the second portion is in a range of from 89.8 degrees to 90.2 degrees.

### Embodiment 9

The clamp according to embodiment 2, wherein an angle between the inner surface of the first portion and the inner surface of the second portion is in a range of from 89.9 degrees to 90.1 degrees.

### Embodiment 10

The clamp according to embodiment 2, wherein an angle between the inner surface of the first portion and the inner surface of the second portion is 90 degrees.

### Embodiment 11

The clamp according to embodiment 2, wherein an angle between the inner surface of the first portion and the inner surface of the second portion in a range of from 80 degrees to 100 degrees.

### Embodiment 12

The clamp according to any of embodiments 2-11, wherein the first portion of the second jaw comprises a multipurpose connector, the second portion of the second jaw comprises a multipurpose connector, or both.

### Embodiment 13

The clamp according to embodiment 12, wherein each multipurpose connector is configured to connect to a rod attachment member.

### Embodiment 14

The clamp according to any of embodiments 2-11, wherein the first portion of the second jaw comprises a homogenously-formed rod receiving member, the second portion of the second jaw comprises a homogenously-formed rod receiving member, or both.

### Embodiment 15

The clamp according to any of embodiments 1-14, wherein the first jaw further comprises a first tab portion,

wherein the second jaw comprises a second tab portion having an inner surface facing the first tab portion,

wherein the first tab portion has an inner surface facing the second tab portion, and

wherein the spring member is configured to apply force to the inner surface of the first tab portion and the inner surface of the second tab portion, thereby pushing the second jaw towards the first jaw.

### Embodiment 16

The clamp according to embodiment 15, wherein the spring member comprises:
a coil;

a first bar portion in contact with the inner surface of the first tab portion;
a first arm portion connecting the first bar portion to the coil;
a second bar portion in contact with the inner surface of the second tab portion; and
a second arm portion connecting the second bar portion to the coil.

### Embodiment 17

The clamp according to any of embodiments 1-16, wherein a tilt angle between the first flat portion and the second flat portion is in a range of from 15 degrees to 55 degrees.

### Embodiment 18

The clamp according to any of embodiments 1-16, wherein a tilt angle between the first flat portion and the second flat portion is in a range of from 10 degrees to 60 degrees.

### Embodiment 19

The clamp according to any of embodiments 1-16, wherein a tilt angle between the first flat portion and the second flat portion is in a range of from 20 degrees to 50 degrees.

### Embodiment 20

The clamp according to any of embodiments 1-16, wherein a tilt angle between the first flat portion and the second flat portion is in a range of from 25 degrees to 45 degrees.

### Embodiment 21

The clamp according to any of embodiments 1-16, wherein a tilt angle between the first flat portion and the second flat portion is in a range of from 30 degrees to 40 degrees.

### Embodiment 22

The clamp according to any of embodiments 1-16, wherein a tilt angle between the first flat portion and the second flat portion is in a range of from 32 degrees to 38 degrees.

### Embodiment 23

The clamp according to any of embodiments 1-16, wherein a tilt angle between the first flat portion and the second flat portion is in a range of from 34 degrees to 36 degrees.

### Embodiment 24

The clamp according to any of embodiments 1-23, wherein a tilt angle between the second flat portion and the third flat portion is in a range of from 15 degrees to 55 degrees.

### Embodiment 25

The clamp according to any of embodiments 1-23, wherein a tilt angle between the second flat portion and the third flat portion is in a range of from 10 degrees to 60 degrees.

### Embodiment 26

The clamp according to any of embodiments 1-23, wherein a tilt angle between the second flat portion and the third flat portion is in a range of from 20 degrees to 50 degrees.

### Embodiment 27

The clamp according to any of embodiments 1-23, wherein a tilt angle between the second flat portion and the third flat portion is in a range of from 25 degrees to 45 degrees.

### Embodiment 28

The clamp according to any of embodiments 1-23, wherein a tilt angle between the second flat portion and the third flat portion is in a range of from 30 degrees to 40 degrees.

### Embodiment 29

The clamp according to any of embodiments 1-23, wherein a tilt angle between the second flat portion and the third flat portion is in a range of from 32 degrees to 38 degrees.

### Embodiment 30

The clamp according to any of embodiments 1-23, wherein a tilt angle between the second flat portion and the third flat portion is in a range of from 34 degrees to 36 degrees.

### Embodiment 31

The clamp according to any of embodiments 1-30, wherein a tilt angle between the first flat portion and the third flat portion is in a range of from 30 degrees to 110 degrees.

### Embodiment 32

The clamp according to any of embodiments 1-30, wherein a tilt angle between the first flat portion and the third flat portion is in a range of from 40 degrees to 100 degrees.

### Embodiment 33

The clamp according to any of embodiments 1-30, wherein a tilt angle between the first flat portion and the third flat portion is in a range of from 50 degrees to 95 degrees.

### Embodiment 34

The clamp according to any of embodiments 1-30, wherein a tilt angle between the first flat portion and the third flat portion is in a range of from 60 degrees to 90 degrees.

### Embodiment 35

The clamp according to any of embodiments 1-30, wherein a tilt angle between the first flat portion and the third flat portion is in a range of from 70 degrees to 85 degrees.

### Embodiment 36

The clamp according to any of embodiments 1-30, wherein a tilt angle between the first flat portion and the third flat portion is in a range of from 68 degrees to 72 degrees.

### Embodiment 37

The clamp according to any of embodiments 1-36, wherein the first jaw further comprises at least one first connection portion,

wherein the second jaw comprises at least one second connection portion, and

wherein the clamp further comprises a screw member provided through each first connection portion, each second connection portion, and at least a portion of the spring member.

### Embodiment 38

A method of affixing an object to a substrate, comprising:
affixing a clamp to the substrate; and
attaching the object to the clamp,
wherein the clamp comprises:
   a first jaw;
   a second jaw connected to the first jaw; and
   a spring member configured to push the first jaw towards the second jaw,
   wherein the first jaw comprises an inner surface having a first flat portion, a second flat portion, and a third flat portion,
   wherein the first flat portion is connected to the second flat portion by a first curved portion, and
   wherein the second flat portion is connected to the third flat portion by a second curved portion.

### Embodiment 39

The method according to embodiment 38, wherein the second jaw comprises:
a second tab portion;
a first portion proximal to the second tab portion and having a substantially flat inner surface; and
a second portion distal to the second tab portion and having a substantially flat inner surface.

### Embodiment 40

The method according to embodiment 39, wherein an angle between the inner surface of the first portion and the inner surface of the second portion is in a range of from 70 degrees to 110 degrees.

### Embodiment 41

The method according to embodiment 39, wherein an angle between the inner surface of the first portion and the inner surface of the second portion is in a range of from 85 degrees to 95 degrees.

### Embodiment 42

The method according to embodiment 39, wherein an angle between the inner surface of the first portion and the inner surface of the second portion is about 90 degrees.

### Embodiment 43

The method according to embodiment 39, wherein an angle between the inner surface of the first portion and the inner surface of the second portion is in a range of from 89 degrees to 91 degrees.

### Embodiment 44

The method according to embodiment 39, wherein an angle between the inner surface of the first portion and the inner surface of the second portion is in a range of from 89.5 degrees to 90.5 degrees.

### Embodiment 45

The method according to embodiment 39, wherein an angle between the inner surface of the first portion and the inner surface of the second portion is in a range of from 89.8 degrees to 90.2 degrees.

### Embodiment 46

The method according to embodiment 39, wherein an angle between the inner surface of the first portion and the inner surface of the second portion is in a range of from 89.9 degrees to 90.1 degrees.

### Embodiment 47

The method according to embodiment 39, wherein an angle between the inner surface of the first portion and the inner surface of the second portion is 90 degrees.

### Embodiment 48

The method according to embodiment 39, wherein an angle between the inner surface of the first portion and the inner surface of the second portion in a range of from 80 degrees to 100 degrees.

### Embodiment 49

The method according to any of embodiments 39-48, wherein the first portion of the second jaw comprises a multipurpose connector, the second portion of the second jaw comprises a multipurpose connector, or both, and

wherein attaching the object to the clamp comprises attaching the object to a multipurpose connector of the second jaw.

### Embodiment 50

The method according to embodiment 49, wherein each multipurpose connector is configured to connect to a rod attachment member, wherein the object comprises a rod.

### Embodiment 51

The method according to any of embodiments 39-48, wherein the first portion of the second jaw comprises a homogenously-formed rod receiving member, the second portion of the second jaw comprises a homogenously-formed rod receiving member, or both, and

wherein attaching the object to the clamp comprises attaching the object to a homogenously-formed rod receiving member of the second jaw.

### Embodiment 52

The method according to any of embodiments 38-51, wherein the first jaw further comprises a first tab portion,

wherein the second jaw comprises a second tab portion having an inner surface facing the first tab portion,

wherein the first tab portion has an inner surface facing the second tab portion, and

wherein the spring member is configured to apply force to the inner surface of the first tab portion and the inner surface of the second tab portion, thereby pushing the second jaw towards the first jaw.

### Embodiment 53

The method according to embodiment 52, wherein the spring member comprises:
a coil;
a first bar portion in contact with the inner surface of the first tab portion;
a first arm portion connecting the first bar portion to the coil;
a second bar portion in contact with the inner surface of the second tab portion; and
a second arm portion connecting the second bar portion to the coil.

### Embodiment 54

The method according to any of embodiments 38-53, wherein a tilt angle between the first flat portion and the second flat portion is in a range of from 15 degrees to 55 degrees.

### Embodiment 55

The method according to any of embodiments 38-53, wherein a tilt angle between the first flat portion and the second flat portion is in a range of from 10 degrees to 60 degrees.

### Embodiment 56

The method according to any of embodiments 38-53, wherein a tilt angle between the first flat portion and the second flat portion is in a range of from 20 degrees to 50 degrees.

### Embodiment 57

The method according to any of embodiments 38-53, wherein a tilt angle between the first flat portion and the second flat portion is in a range of from 25 degrees to 45 degrees.

### Embodiment 58

The method according to any of embodiments 38-53, wherein a tilt angle between the first flat portion and the second flat portion is in a range of from 30 degrees to 40 degrees.

### Embodiment 59

The method according to any of embodiments 38-53, wherein a tilt angle between the first flat portion and the second flat portion is in a range of from 32 degrees to 38 degrees.

### Embodiment 60

The method according to any of embodiments 38-53, wherein a tilt angle between the first flat portion and the second flat portion is in a range of from 34 degrees to 36 degrees.

### Embodiment 61

The method according to any of embodiments 38-60, wherein a tilt angle between the second flat portion and the third flat portion is in a range of from 15 degrees to 55 degrees.

### Embodiment 62

The method according to any of embodiments 38-60, wherein a tilt angle between the second flat portion and the third flat portion is in a range of from 10 degrees to 60 degrees.

### Embodiment 63

The method according to any of embodiments 38-60, wherein a tilt angle between the second flat portion and the third flat portion is in a range of from 20 degrees to 50 degrees.

### Embodiment 64

The method according to any of embodiments 38-60, wherein a tilt angle between the second flat portion and the third flat portion is in a range of from 25 degrees to 45 degrees.

### Embodiment 65

The method according to any of embodiments 38-60, wherein a tilt angle between the second flat portion and the third flat portion is in a range of from 30 degrees to 40 degrees.

### Embodiment 66

The method according to any of embodiments 38-60, wherein a tilt angle between the second flat portion and the third flat portion is in a range of from 32 degrees to 38 degrees.

### Embodiment 67

The method according to any of embodiments 38-60, wherein a tilt angle between the second flat portion and the third flat portion is in a range of from 34 degrees to 36 degrees.

### Embodiment 68

The method according to any of embodiments 38-67, wherein a tilt angle between the first flat portion and the third flat portion is in a range of from 30 degrees to 110 degrees.

### Embodiment 69

The method according to any of embodiments 38-67, wherein a tilt angle between the first flat portion and the third flat portion is in a range of from 40 degrees to 100 degrees.

### Embodiment 70

The method according to any of embodiments 38-67, wherein a tilt angle between the first flat portion and the third flat portion is in a range of from 50 degrees to 95 degrees.

### Embodiment 71

The method according to any of embodiments 38-67, wherein a tilt angle between the first flat portion and the third flat portion is in a range of from 60 degrees to 90 degrees.

### Embodiment 72

The method according to any of embodiments 38-67, wherein a tilt angle between the first flat portion and the third flat portion is in a range of from 70 degrees to 85 degrees.

### Embodiment 73

The method according to any of embodiments 38-67, wherein a tilt angle between the first flat portion and the third flat portion is in a range of from 68 degrees to 72 degrees.

### Embodiment 74

The method according to any of embodiments 38-73, wherein the first jaw further comprises at least one first connection portion,

wherein the second jaw comprises at least one second connection portion, and

wherein the clamp further comprises a screw member provided through each first connection portion, each second connection portion, and at least a portion of the spring member.

### Embodiment 75

A method of forming a clamp, comprising:
forming a first jaw;
forming a second jaw;
connecting the first jaw to the second jaw; and
connecting a spring member to the first jaw and the second jaw,
wherein the spring member is configured to push the first jaw towards the second jaw,
wherein the first jaw comprises an inner surface having a first flat portion, a second flat portion, and a third flat portion,
wherein the first flat portion is connected to the second flat portion by a first curved portion, and
wherein the second flat portion is connected to the third flat portion by a second curved portion.

### Embodiment 76

The method according to embodiment 75, wherein the second jaw comprises:
a second tab portion;
a first portion proximal to the second tab portion and having a substantially flat inner surface; and
a second portion distal to the second tab portion and having a substantially flat inner surface.

### Embodiment 77

The method according to embodiment 76, wherein the second jaw is formed such that an angle between the inner surface of the first portion and the inner surface of the second portion is in a range of from 70 degrees to 110 degrees.

### Embodiment 78

The method according to embodiment 76, wherein the second jaw is formed such that an angle between the inner surface of the first portion and the inner surface of the second portion is in a range of from 85 degrees to 95 degrees.

### Embodiment 79

The method according to embodiment 76, wherein the second jaw is formed such that an angle between the inner surface of the first portion and the inner surface of the second portion is about 90 degrees.

### Embodiment 80

The method according to embodiment 76, wherein the second jaw is formed such that an angle between the inner surface of the first portion and the inner surface of the second portion is in a range of from 89 degrees to 91 degrees.

### Embodiment 81

The method according to embodiment 76, wherein the second jaw is formed such that an angle between the inner surface of the first portion and the inner surface of the second portion is in a range of from 89.5 degrees to 90.5 degrees.

### Embodiment 82

The method according to embodiment 76, wherein the second jaw is formed such that an angle between the inner surface of the first portion and the inner surface of the second portion is in a range of from 89.8 degrees to 90.2 degrees.

### Embodiment 83

The method according to embodiment 76, wherein the second jaw is formed such that an angle between the inner surface of the first portion and the inner surface of the second portion is in a range of from 89.9 degrees to 90.1 degrees.

### Embodiment 84

The method according to embodiment 76, wherein the second jaw is formed such that an angle between the inner surface of the first portion and the inner surface of the second portion is 90 degrees.

### Embodiment 85

The method according to embodiment 76, wherein the second jaw is formed such that an angle between the inner surface of the first portion and the inner surface of the second portion in a range of from 80 degrees to 100 degrees.

### Embodiment 86

The method according to any of embodiments 76-85, wherein the first portion of the second jaw comprises a multipurpose connector, the second portion of the second jaw comprises a multipurpose connector, or both.

### Embodiment 87

The method according to embodiment 86, wherein each multipurpose connector is configured to connect to a rod attachment member.

### Embodiment 88

The method according to any of embodiments 76-85, wherein the first portion of the second jaw comprises a homogenously-formed rod receiving member, the second portion of the second jaw comprises a homogenously-formed rod receiving member, or both.

### Embodiment 89

The method according to any of embodiments 75-88, wherein the first jaw further comprises a first tab portion,

wherein the second jaw comprises a second tab portion having an inner surface facing the first tab portion,

wherein the first tab portion has an inner surface facing the second tab portion, and

wherein the spring member is configured to apply force to the inner surface of the first tab portion and the inner surface of the second tab portion, thereby pushing the second jaw towards the first jaw.

### Embodiment 90

The method according to embodiment 89, wherein the spring member comprises:
a coil;
a first bar portion in contact with the inner surface of the first tab portion;
a first arm portion connecting the first bar portion to the coil;
a second bar portion in contact with the inner surface of the second tab portion; and
a second arm portion connecting the second bar portion to the coil.

### Embodiment 91

The method according to any of embodiments 75-90, wherein a tilt angle between the first flat portion and the second flat portion is in a range of from 15 degrees to 55 degrees.

### Embodiment 92

The method according to any of embodiments 75-90, wherein a tilt angle between the first flat portion and the second flat portion is in a range of from 10 degrees to 60 degrees.

### Embodiment 93

The method according to any of embodiments 75-90, wherein a tilt angle between the first flat portion and the second flat portion is in a range of from 20 degrees to 50 degrees.

### Embodiment 94

The method according to any of embodiments 75-90, wherein a tilt angle between the first flat portion and the second flat portion is in a range of from 25 degrees to 45 degrees.

### Embodiment 95

The method according to any of embodiments 75-90, wherein a tilt angle between the first flat portion and the second flat portion is in a range of from 30 degrees to 40 degrees.

### Embodiment 96

The method according to any of embodiments 75-90, wherein a tilt angle between the first flat portion and the second flat portion is in a range of from 32 degrees to 38 degrees.

### Embodiment 97

The method according to any of embodiments 75-90, wherein a tilt angle between the first flat portion and the second flat portion is in a range of from 34 degrees to 36 degrees.

### Embodiment 98

The method according to any of embodiments 75-97, wherein a tilt angle between the second flat portion and the third flat portion is in a range of from 15 degrees to 55 degrees.

### Embodiment 99

The method according to any of embodiments 75-97, wherein a tilt angle between the second flat portion and the third flat portion is in a range of from 10 degrees to 60 degrees.

### Embodiment 100

The method according to any of embodiments 75-97, wherein a tilt angle between the second flat portion and the third flat portion is in a range of from 20 degrees to 50 degrees.

### Embodiment 101

The method according to any of embodiments 75-97, wherein a tilt angle between the second flat portion and the third flat portion is in a range of from 25 degrees to 45 degrees.

### Embodiment 102

The method according to any of embodiments 75-97, wherein a tilt angle between the second flat portion and the third flat portion is in a range of from 30 degrees to 40 degrees.

### Embodiment 103

The method according to any of embodiments 75-97, wherein a tilt angle between the second flat portion and the third flat portion is in a range of from 32 degrees to 38 degrees.

### Embodiment 104

The method according to any of embodiments 75-97, wherein a tilt angle between the second flat portion and the third flat portion is in a range of from 34 degrees to 36 degrees.

### Embodiment 105

The method according to any of embodiments 75-104, wherein a tilt angle between the first flat portion and the third flat portion is in a range of from 30 degrees to 110 degrees.

### Embodiment 106

The method according to any of embodiments 75-104, wherein a tilt angle between the first flat portion and the third flat portion is in a range of from 40 degrees to 100 degrees.

### Embodiment 107

The method according to any of embodiments 75-104, wherein a tilt angle between the first flat portion and the third flat portion is in a range of from 50 degrees to 95 degrees.

### Embodiment 108

The method according to any of embodiments 75-104, wherein a tilt angle between the first flat portion and the third flat portion is in a range of from 60 degrees to 90 degrees.

### Embodiment 109

The method according to any of embodiments 75-104, wherein a tilt angle between the first flat portion and the third flat portion is in a range of from 70 degrees to 85 degrees.

### Embodiment 110

The method according to any of embodiments 75-104, wherein a tilt angle between the first flat portion and the third flat portion is in a range of from 68 degrees to 72 degrees.

### Embodiment 111

The method according to any of embodiments 75-110, wherein the first jaw further comprises at least one first connection portion,

wherein the second jaw comprises at least one second connection portion,

wherein connecting the first jaw to the second jaw comprises inserting a screw member through each first connection portion and each second connection portion, and

wherein connecting the spring member to the first jaw and the second jaw comprises inserting the screw member through at least a portion of the spring member.

All patents, patent applications, provisional applications, and publications referred to or cited herein are incorporated by reference in their entirety, including all figures and tables, to the extent they are not inconsistent with the explicit teachings of this specification.

### EXAMPLES

Following are examples that illustrate procedures for practicing the invention. These examples should not be construed as limiting. All percentages are by weight and all solvent mixture proportions are by volume unless otherwise noted.

### Example 1

Referring to FIG. 15, a (red) clamp was constructed, including a spring member 15, a first jaw 20 having a tab portion 45, and a second jaw 50 having a tab portion 75. The spring member was configured to apply force against the inner surfaces (surfaces facing the other tab portion) of both tab portions. The first jaw had an inner surface with three flat portions: a first flat portion 21 connected to a second flat portion 22 by a first curved portion 24, and a third flat portion 23 connected to the second flat portion 22 by a second curved portion 25. The second jaw had a first portion 51 proximal to the tab portion and a second portion 52 distal to the tab portion. The first 51 and second 52 portions were at an angle of about 90 degrees with respect to one another. The clamp also had two homogenously-formed rod receiving members 102, one each on the first portion 51 and the second portion 52 of the second jaw 50. Each rod receiving member 102 had four homogenously-formed reinforcing members 103. The clamp easily gripped the frame of a picture frame assembly.

Referring to FIG. 16, the clamp comfortably grips the edge of a shelf while having a rod 200 attached to it via insertion into the rod receiving member 102 of the second portion 52 of the second jaw 50.

Referring to FIG. 17, the clamp once again comfortably grips the edge of a shelf, which has a different size than either of the substrates in FIGS. 15 and 16.

Referring to FIG. 18, the large contact area generated between the clamp and the substrate can be seen; this is as a result of the advantageous shape of the first jaw. In this example, even though the substrate is relatively narrow compared to the size of the clamp, the third flat portion 23 makes good contact with the substrate, thereby ensuring high friction and strong clamping, and inhibiting tilting, slipping, or losing grip.

### Example 2

Referring again to FIG. 15, a (white) clamp was constructed, including a spring member 15, a first jaw 20 having a tab portion 45, and a second jaw 50 having a tab portion 75. The spring member was configured to apply force against the inner surfaces (surfaces facing the other tab portion) of both tab portions. The first jaw had an inner surface with three flat portions:

a first flat portion 21 connected to a second flat portion 22 by a first curved portion 24, and a third flat portion 23 connected to the second flat portion 22 by a second curved portion 25. The second jaw had a first portion 51 proximal to the tab portion and a second portion 52 distal to the tab portion. The first 51 and second 52 portions were at an angle of about 90 degrees with respect to one another. The clamp also had two homogenously-formed rod receiving members 102, one each on the first portion 51 and the second portion 52 of the second jaw 50. Each rod receiving member 102 had four homogenously-formed reinforcing members 103. The clamp easily gripped the frame of a picture frame assembly.

Referring to FIG. 19, the clamp can be seen comfortably gripping a substrate that it is an odd thickness compared to the size of the clamp. Due to the advantageous shape of the first jaw, the smooth, gradual curve of the second curved portion 25 ensures a large amount of surface area contact between the first jaw and the substrate to which it is clamped, whereas a sharp edge between flat portions would decrease the surface area contact between the first jaw and this substrate. This helps the second jaw “find the corner” where the first portion meets the second portion 52, even though there is a load attached (rod 200).

Referring to FIG. 20, the clamp comfortably grips even an extremely narrow substrate, providing a large amount of surface contact area between the third surface 23 and the narrow, cardboard substrate.

Referring to FIG. 21, the clamp easily grips a substrate that is very thick relative to the clamp size and much, much thicker than the substrate in FIG. 20. The advantageous shape of the first jaw ensures a large amount of surface contact area and once again helps the second jaw “find the corner” where the first portion 51 meets the second portion 52, even though there is a load attached (rod 200).

Referring to FIG. 23, the clamp grips a substrate that has gaps and protrusions where the first jaw makes contact. However, again due to the advantageous shape of the first jaw, a large amount of surface contact is generated between the first jaw and the substrate. In this case, multiple portions of the first jaw make contact with the substrate, providing excellent stability to the clamp.

### Example 3

Referring to FIG. 22, a (blue) clamp was constructed, including a spring member 15, a first jaw 20 having a tab portion 45, and a second jaw 50 having a tab portion 75. The spring member was configured to apply force against the inner surfaces (surfaces facing the other tab portion) of both tab portions. The first jaw had an inner surface with three flat portions: a first flat portion 21 connected to a second flat portion 22 by a first curved portion 24, and a third flat portion 23 connected to the second flat portion 22 by a second curved portion 25. The second jaw had a first portion 51 proximal to the tab portion and a second portion 52 distal to the tab portion. The first 51 and second 52 portions were at an angle of about 90 degrees with respect to one another. The clamp also had two homogenously-formed rod receiving members 102, one each on the first portion 51 and the second portion 52 of the second jaw 50. Each rod receiving member 102 had four homogenously-formed reinforcing members 103. The clamp comfortably grips an extremely thick piece of wood that is much larger than the substrate of FIG. 20. Due to the advantageous shape of the first jaw, the first flat portion 21 is able to generate a large amount of surface contact between the first jaw and the substrate to which it is clamped. The clamp was not affected by the attachment of a rod 200.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A clamp, comprising:
a first jaw;
a second jaw connected to the first jaw; and
a spring member configured to push the first jaw towards the second jaw,
wherein the first jaw comprises an inner surface having a first flat portion, a second flat portion, and a third flat portion,
wherein the first flat portion is connected to the second flat portion by a first curved portion, and
wherein the second flat portion is connected to the third flat portion by a second curved portion.

2. The clamp according to claim 1, wherein the second jaw comprises:
a second tab portion;
a first portion proximal to the second tab portion and having a substantially flat inner surface; and
a second portion distal to the second tab portion and having a substantially flat inner surface, and
wherein an angle between the inner surface of the first portion and the inner surface of the second portion is in a range of from 70 degrees to 110 degrees.

3. The clamp according to claim 2, wherein the first portion of the second jaw comprises a multipurpose connector, the second portion of the second jaw comprises a multipurpose connector, or both.

4. The clamp according to claim 3, wherein each multipurpose connector is configured to connect to a rod attachment member.

5. The clamp according to claim 2, wherein the first portion of the second jaw comprises a homogenously-formed rod receiving member, the second portion of the second jaw comprises a homogenously-formed rod receiving member, or both.

6. The clamp according to claim 1, wherein the first jaw further comprises a first tab portion,
wherein the second jaw comprises a second tab portion having an inner surface facing the first tab portion,
wherein the first tab portion has an inner surface facing the second tab portion, and
wherein the spring member is configured to apply force to the inner surface of the first tab portion and the inner surface of the second tab portion, thereby pushing the second jaw towards the first jaw.

7. The clamp according to claim 6, wherein the spring member comprises:
a coil;
a first bar portion in contact with the inner surface of the first tab portion;
a first arm portion connecting the first bar portion to the coil;
a second bar portion in contact with the inner surface of the second tab portion; and
a second arm portion connecting the second bar portion to the coil,

8. The clamp according to claim 1, wherein a tilt angle between the first flat portion
and the second flat portion is in a range of from 15 degrees to 55 degrees,
wherein a tilt angle between the second flat portion and the third flat portion is in a range of from 15 degrees to 55 degrees.

9. The clamp according to claim 1, wherein the first jaw further comprises at least one first connection portion,
wherein the second jaw comprises at least one second connection portion, and
wherein the clamp further comprises a screw member provided through each first connection portion, each second connection portion, and at least a portion of the spring member.

10. A method of affixing an object to a substrate, comprising:
affixing a clamp to the substrate; and
attaching the object to the clamp,
wherein the clamp comprises:
a first jaw;
a second jaw connected to the first jaw; and
a spring member configured to push the first jaw towards the second jaw,
wherein the first jaw comprises an inner surface having a first flat portion, a second flat portion, and a third flat portion,
wherein the first flat portion is connected to the second flat portion by a first curved portion, and
wherein the second flat portion is connected to the third flat portion by a second curved portion.

11. The method according to claim 10, wherein the second jaw comprises:
a second tab portion;
a first portion proximal to the second tab portion and having a substantially flat inner surface; and
a second portion distal to the second tab portion and having a substantially flat inner surface, and
wherein an angle between the inner surface of the first portion and the inner surface of the second portion is in a range of from 70 degrees to 110 degrees.

12. The method according to claim 11, wherein the first portion of the second jaw comprises a homogenously-formed rod receiving member, the second portion of the second jaw comprises a homogenously-formed rod receiving member, or both, and
wherein attaching the object to the clamp comprises attaching the object to a homogenously-formed rod receiving member of the second jaw.

13. The method according to claim 10, wherein a tilt angle between the first flat portion and the second flat portion is in a range of from 15 degrees to 55 degrees,
wherein a tilt angle between the second flat portion and the third flat portion is in a range of from 15 degrees to 55 degrees.

14. The method according to claim 10, wherein the first jaw further comprises at least one first connection portion,
wherein the second jaw comprises at least one second connection portion, and
wherein the clamp further comprises a screw member provided through each first connection portion, each second connection portion, and at least a portion of the spring member.

15. A method of forming a clamp, comprising:
forming a first jaw;
forming a second jaw;
connecting the first jaw to the second jaw; and
connecting a spring member to the first jaw and the second jaw,
wherein the spring member is configured to push the first jaw towards the second jaw,
wherein the first jaw comprises an inner surface having a first flat portion, a second flat portion, and a third flat portion,
wherein the first flat portion is connected to the second flat portion by a first curved portion, and
wherein the second flat portion is connected to the third flat portion by a second curved portion.

16. The method according to claim 14, wherein the second jaw comprises:
a second tab portion;
a first portion proximal to the second tab portion and having a substantially flat inner surface; and
a second portion distal to the second tab portion and having a substantially flat inner surface, and
wherein the second jaw is formed such that an angle between the inner surface of the first portion and the inner surface of the second portion is in a range of from 70 degrees to 110 degrees.

17. The method according to claim 16, wherein the first portion of the second jaw comprises a homogenously-formed rod receiving member, the second portion of the second jaw comprises a homogenously-formed rod receiving member, or both.

18. The method according to claim 15, wherein the first jaw further comprises a first tab portion,
wherein the second jaw comprises a second tab portion having an inner surface facing the first tab portion,
wherein the first tab portion has an inner surface facing the second tab portion, and
wherein the spring member is configured to apply force to the inner surface of the first tab portion and the inner surface of the second tab portion, thereby pushing the second jaw towards the first jaw.

19. The method according to claim 15, wherein the first jaw is formed such that a tilt angle between the first flat portion and the second flat portion is in a range of from 15 degrees to 55 degrees, and a tilt angle between the second flat portion and the third flat portion is in a range of from 15 degrees to 55 degrees.

20. The method according to claim 15, wherein the first jaw further comprises at least one first connection portion,
wherein the second jaw comprises at least one second connection portion,
wherein connecting the first jaw to the second jaw comprises inserting a screw member through each first connection portion and each second connection portion, and
wherein connecting the spring member to the first jaw and the second jaw comprises inserting the screw member through at least a portion of the spring member.
